(19) United States
(12) Patent Application Publication
(10) Pub. No.: US 2025/0179280 A1
(43) Pub. Date: Jun. 5, 2025

(54) GLASS FIBER REINFORCED POLYPROPYLENE COMPOSITION

(71) Applicant: BOREALIS AG, Vienna (AT)

(72) Inventors: Jingbo Wang, Linz (AT); Markus Gahleitner, Linz (AT); Klaus Bernreitner, Linz (AT); Pauli Leskinen, Porvoo (FI); Georg Grestenberger, Linz (AT); Katja Klimke, Linz (AT)

(21) Appl. No.: 18/845,135

(22) PCT Filed: Mar. 20, 2023
(86) PCT No.: PCT/EP2023/056997

§ 371 Date: Sep. 9, 2024

(30) Foreign Application Priority Data
Mar. 21, 2022 (EP) 22163139.3

(51) Int. Cl. C08L 23/14; C08K 7/14

(52) U.S. Cl. CPC C08L 23/14; C08K 7/14; C08K 2201/003; C08K 2201/004; C08L 2205/025; C08L 2205/035; C08L 2207/02; C08L 2314/06

(57) ABSTRACT

The invention relates to a fiber reinforced composition (C), wherein the fiber reinforced composition (C) has a melt flow rate MFR₂ (230° C., 2.16 kg) determined according to ISO 1133 in the range of 10.0 to 100.0 g/10 min, wherein the fiber reinforced composition (C) comprises a) 20.0 to 89.9 wt.-% of a propylene random copolymer (P), wherein the propylene random copolymer (P) is a copolymer of propylene and at least one comonomer selected from C4 to C12 α-olefins, wherein the propylene random copolymer (P) has an amount of 1,2 erythro regio-defects of 0.4 to 1.2 mol-%, b) 5.0 to 45.0 wt.-% of glass fibers (GF), c) 0.1 to 5.0 wt.-% of an adhesion promoter (AP), and d) 5.0 to 50.0 wt.-% of a heterophasic polypropylene copolymer (HECO), based on the overall weight of the fiber reinforced composition (C). Furthermore, the invention relates to articles comprising such fiber reinforced composition (C).

### FIELD OF INVENTION

The present invention relates to glass fiber reinforced polypropylene compositions and articles comprising glass fiber reinforced polypropylene compositions.

### BACKGROUND OF INVENTION

Glass fiber reinforced materials are used for many technical applications. Glass fiber reinforced materials are especially useful in the engineering area, where high stiffness, high heat deflection temperature (HDT) and good impact resistance are often required. Polypropylene is one of the most popular base polymers for preparing glass fiber reinforced materials. This is mainly due to the diversity, low cost and low density of polypropylene. One type of polypropylene which is used as base polymer in glass fiber reinforced materials is polypropylene which has been obtained in the presence of a metallocene- or single-site catalyst.

However, available polypropylenes obtained by metallocene- or single-site catalysis have intrinsic drawbacks: the stiffness is not high enough and HDT is low. Furthermore, in some specific areas of applications such as exterior, a specific ductility can be needed.

Therefore, it is desirable to obtain a glass fiber reinforced polypropylene composition which combines the properties of good ductility, high HDT and good impact resistance. It is further desired that the glass fiber reinforced polypropylene composition has a low emission, e.g. a low emission of volatile organic compounds (VOC). Moreover, a comparatively high melt flow rate (MFR) is necessary for processing the composition by means of injection molding (IM).

### SUMMARY OF INVENTION

One aspect of the invention provides a fiber reinforced composition (C). The fiber reinforced composition (C) has a melt flow rate MFR₂ (230° C., 2.16 kg) determined according to ISO 1133 in the range of 10.0 to 100.0 g/10 min. The fiber reinforced composition (C) comprises
a) 20.0 to 89.9 wt.-% of a propylene random copolymer (P), wherein the propylene random copolymer (P) is a copolymer of propylene and at least one comonomer selected from C4 to C12 α-olefins, wherein the propylene random copolymer (P) has an amount of 1,2 erythro regio-defects in the range of 0.4 to 1.2 mol-%,
b) 5.0 to 45.0 wt.-% of glass fibers (GF),
c) 0.1 to 5.0 wt.-% of an adhesion promoter (AP), and
d) 5.0 to 50.0 wt.-% of a heterophasic polypropylene copolymer (HECO), based on the overall weight of the fiber reinforced composition (C).

It has surprisingly been found that desired properties can be achieved by a glass fiber reinforced polypropylene composition comprising the specific high flow random copolymer as described herein, glass fibers, a heterophasic polypropylene copolymer and an adhesion promoter. In particular, the fiber reinforced composition according to the invention has improved HDT and ductility, a high impact resistance and stiffness. The hydrocarbon emissions of the inventive composition are low, and the melt flow has an appropriate level for IM processing.

Another aspect of the invention provides an article comprising the fiber reinforced composition (C) according to the invention.

Preferred embodiments of the invention are defined in the dependent claims.

According to one embodiment, the propylene random copolymer (P) has a melting temperature Tm determined according to differential scanning calorimetry (DSC) in the range of 125 to 150° C.

According to one embodiment, the propylene random copolymer (P) has a comonomer content in the range of 2.5 to 10.0 mol-%.

According to one embodiment, the propylene random copolymer (P) has a melt flow rate MFR₂ (230° C., 2.16 kg) determined according to ISO 1133 in the range of 45 to 150 g/10 min.

According to one embodiment, the propylene random copolymer (P) is a copolymer of propylene and 1-butene.

According to one embodiment, the propylene random copolymer (P) comprises
i) a first propylene random copolymer (P1), and
ii) a second propylene random copolymer (P2) having a higher comonomer content than the first propylene random copolymer (P1),
wherein the weight ratio between the first propylene random copolymer (P1) and the second propylene random copolymer (P2) is in the range of 20/80 to 60/40 and the combined amount of the first propylene random copolymer (P1) and the second propylene random copolymer (P2) is at least 95.0 wt.-%, based on the propylene random copolymer (P).

According to one embodiment, the propylene random copolymer (P) comprises
i) a first propylene random copolymer (P1) having a comonomer content in the range of 2.0 to 6.0 mol-%, and
ii) a second propylene random copolymer (P2) having a comonomer content in the range of 4.0 to 14.0 mol-%, wherein the comonomer content of the second propylene random copolymer (P2) is higher, than the comonomer content of the first propylene random copolymer (P1).

According to one embodiment, the glass fibers (GF) have
i) an average length of 1.0 to 10.0 mm, and/or
ii) an average diameter of 5 to 20 μm.

According to one embodiment, the adhesion promoter (AP) is a polar modified propylene homo- or copolymer (PM-PP), preferably comprising polar groups selected from the group consisting of acid anhydrides, carboxylic acids, carboxylic acid derivatives, primary and secondary amines, hydroxyl compounds, oxazoline and epoxides, ionic compounds, and combinations thereof.

According to one embodiment, the heterophasic polypropylene copolymer (HECO) comprises
i) a matrix being a propylene homopolymer (hPP), and
ii) an elastomeric ethylene copolymer (E) being dispersed in said matrix, wherein the elastomeric ethylene polymer (E) is a copolymer of ethylene and propylene, and optionally at least one comonomer selected from C4 to C12 α-olefins (e.g. 1-butene or 1-hexene).

According to one embodiment, the heterophasic polypropylene copolymer (HECO) has one or more of:
i) an ethylene content of the xylene cold soluble (XCS) fraction in the range of 20.0 to 55.0 wt. %,
ii) a xylene cold soluble (XCS) content determined at 25° C. according ISO 16152 in the range of 5.0 to 45.0 wt. %, based on the overall weight of the heterophasic polypropylene copolymer (HECO),
iii) an intrinsic viscosity (IV) determined according to DIN ISO 1628/1 in decalin at 135° C. of the XCS fraction of from 1.5 to 6.0 dl/g.

According to one embodiment, the heterophasic polypropylene copolymer (HECO) has a melt flow rate MFR₂ (230° C., 2.16 kg) determined according to ISO 1133 in the range of 4.0 to 50.0 g/10 min.

According to one embodiment, the heterophasic polypropylene copolymer (HECO) has a melting temperature Tm determined according to differential scanning calorimetry (DSC) in the range of 150 to 170° C.

According to one embodiment, the propylene random copolymer (P) is obtained in the presence of a solid catalyst system (SCS) comprising a metallocene compound.

According to one embodiment, the solid catalyst system (SCS) comprises (i) a metallocene compound of formula (I):

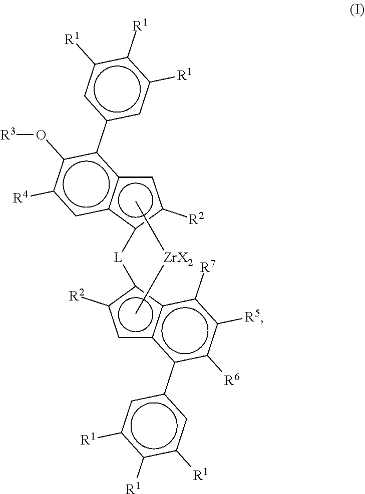

each X independently is a sigma-donor ligand,
L is a divalent bridge selected from —R′₂C—, —R′₂C—CR′₂—, —R′₂Si—, —R′₂Si—SiR′₂—, —R′₂Ge—, wherein each R′ is independently a hydrogen atom or a C₁-C₂₀-hydrocarbyl group optionally containing one or more heteroatoms of Group 14-16 of the periodic table or fluorine atoms, or optionally two R′ groups taken together form a ring,
each R¹ are independently the same or different, and are hydrogen, a linear or branched C₁-C₆-alkyl group, a C₇₋₂₀ arylalkyl, C₇₋₂₀ alkylaryl group or C₆₋₂₀ aryl group or an OY group, wherein Y is a C₁₋₁₀ hydrocarbyl group, and optionally two adjacent R¹ groups are part of a ring including the phenyl carbons to which they are bonded,
each R² independently are the same or different, and are a CH₂—R⁸ group, with R⁸ being H or linear or branched C₁₋₆-alkyl group, C₃₋₈ cycloalkyl group, C₆₋₁₀ aryl group,
R³ is a linear or branched C₁-C₆-alkyl group, C₇₋₂₀ arylalkyl, C₇₋₂₀ alkylaryl group or C₆-C₂₀-aryl group,
R⁴ is a C(R⁹)₃ group, with R⁹ being a linear or branched C₁-C₆ alkyl group,
R⁵ is hydrogen or an aliphatic C₁-C₂₀ hydrocarbyl group optionally containing one or more heteroatoms from groups 14-16 of the periodic table of elements;
R⁶ is hydrogen or an aliphatic C₁-C₂₀ hydrocarbyl group optionally containing one or more heteroatoms from groups 14-16 of the periodic table of elements; or
R⁵ and R⁶ are optionally taken together to form a 5 membered saturated carbon ring which is optionally substituted by n groups R¹⁰, n being from 0 to 4;
each R¹⁰ is same or different, and may be a C₁-C₂₀ hydrocarbyl group, or a C₁-C₂₀ hydrocarbyl radical optionally containing one or more heteroatoms belonging to groups 14-16 of the periodic table of elements;
R⁷ is H or a linear or branched C₁-C₆-alkyl group or an aryl or heteroaryl group having 6 to 20 carbon atoms optionally substituted by one to 3 groups R¹,
(ii) a cocatalyst system comprising a boron containing cocatalyst and/or an aluminoxane cocatalyst and
(iii) optionally a silica support

Where the term “comprising” is used in the present description and claims, it does not exclude other non-specified elements of major or minor functional importance. For the purposes of the present invention, the term “essentially consisting of” and “consisting of” are considered to be specific embodiments of the term “comprising of”. If hereinafter a group is defined to comprise at least a certain number of features or embodiments, this is also to be understood to disclose a group, which optionally essentially consists only of these features or embodiments or consists only of these features or embodiments. Whenever the terms “including” or “having” are used, these terms are meant to be equivalent to “comprising” as defined above.

In the following, the present invention is described in more detail.

### DETAILED DESCRIPTION

### The Fiber Reinforced Composition (C)

The fiber reinforced composition (C) comprises a propylene random copolymer (P), glass fibers (GF), a heterophasic polypropylene copolymer (HECO), and an adhesion promoter (AP).

In particular, the fiber reinforced composition (C) comprises
a) 20.0 to 89.9 wt.-%, preferably 25.0 to 79.5 wt.-%, more preferably 30.0 to 64.0 wt.-%, and even more preferably 35.0 to 54.0 wt. %, like in the range of 38.25 to 48.75 wt.-%, of the propylene random copolymer (P),
b) 5.0 to 45.0 wt.-%, preferably 10.0 to 40.0 wt.-%, more preferably 15.0 to 35.0 wt.-%, even more preferably 15.0 to 25.0 wt.-%, like in the range of 17.5 to 22.5 wt.-%), of glass fibers (GF),
c) 0.1 to 5.0 wt.-%, preferably 0.5 to 3.0 wt.-%, more preferably 1.0 to 2.5 wt.-%, even more preferably 1.0 to 2.0 wt. %, like in the range of 1.25 to 1.75 wt.-%, of an adhesion promoter (AP), and
d) 5.0 to 50.0 wt.-%, preferably 10.0 to 50.0 wt.-%, more preferably 20.0 to 45.0 wt.-%, even more preferably 30.0 to 40.0 wt.-%, like in the range of 32.5 to 37.5 wt.-%, of a heterophasic polypropylene copolymer (HECO), based on the overall weight of the fiber reinforced composition (C).

According to one embodiment, the fiber reinforced composition (C) comprises, optionally consists of,
a) 20.0 to 89.9 wt.-%, preferably 25.0 to 79.5 wt.-%, more preferably 30.0 to 64.0 wt.-%, and even more preferably 35.0 to 54.0 wt. %, like in the range of 38.25 to 48.75 wt.-%, of the propylene random copolymer (P),
b) 5.0 to 45.0 wt.-%, preferably 10.0 to 40.0 wt.-%, more preferably 15.0 to 35.0 wt.-%, even more preferably 15.0 to 25.0 wt.-%, like in the range of 17.5 to 22.5 wt.-%, of glass fibers (GF),
c) 0.1 to 5.0 wt.-%, preferably 0.5 to 3.0 wt.-%, more preferably 1.0 to 2.5 wt.-%, even more preferably 1.0 to 2.0 wt. %, like in the range of 1.25 to 1.75 wt.-%, of an adhesion promoter (AP), and
d) 5.0 to 50.0 wt.-%, preferably 10.0 to 50.0 wt.-%, more preferably 20.0 to 45.0 wt.-%, even more preferably 30.0 to 40.0 wt.-%, like in the range of 32.5 to 37.5 wt.-%, of a heterophasic polypropylene copolymer (HECO),
based on the overall weight of the fiber reinforced composition (C), and wherein components a) to d) add up to 100 wt.-%.

The fiber reinforced composition (C) preferably comprises additives (AD). According to one preferred embodiment, the fiber reinforced composition (C) comprises
a) 20.0 to 89.89 wt.-%, preferably 25.0 to 79.4 wt.-%, more preferably 30.0 to 63.9 wt.-%, and even more preferably 35.0 to 53.5 wt. %, like in the range of 38.25 to 47.75 wt.-%, of the propylene random copolymer (P),
b) 5.0 to 45.0 wt.-%, preferably 10.0 to 40.0 wt.-%, more preferably 15.0 to 35.0 wt.-%, even more preferably 15.0 to 25.0 wt.-%, like in the range of 17.5 to 22.5 wt.-%, of glass fibers (GF),
c) 0.1 to 5.0 wt.-%, preferably 0.5 to 3.0 wt.-%, more preferably 1.0 to 2.5 wt.-%, even more preferably 1.0 to 2.0 wt. %, like in the range of 1.25 to 1.75 wt.-%, of an adhesion promoter (AP), and
d) 5.0 to 50.0 wt.-%, preferably 10.0 to 50.0 wt.-%, more preferably 20.0 to 45.0 wt.-%, even more preferably 30.0 to 40.0 wt.-%, like in the range of 32.5 to 37.5 wt.-%, of a heterophasic polypropylene copolymer (HECO),
e) 0.01 to 5.0 wt.-%, preferably 0.1 to 4.0 wt.-%, more preferably 0.1 to 3.0 wt.-%, even more preferably 0.5 to 2.5 wt. %, like in the range of 1.0 to 2.0 wt.-%, of additives (AD),
based on the overall weight of the fiber reinforced composition (C).

According to one preferred embodiment, the fiber reinforced composition (C) comprises, preferably consists of,
a) 20.0 to 89.89 wt.-%, preferably 25.0 to 79.4 wt.-%, more preferably 30.0 to 63.9 wt.-%, and even more preferably 35.0 to 53.5 wt. %, like in the range of 38.25 to 47.75 wt.-%, of the propylene random copolymer (P),
b) 5.0 to 45.0 wt.-%, preferably 10.0 to 40.0 wt.-%, more preferably 15.0 to 35.0 wt.-%, even more preferably 15.0 to 25.0 wt.-%, like in the range of 17.5 to 22.5 wt.-%, of glass fibers (GF),
c) 0.1 to 5.0 wt.-%, preferably 0.5 to 3.0 wt.-%, more preferably 1.0 to 2.5 wt.-%, even more preferably 1.0 to 2.0 wt. %, like in the range of 1.25 to 1.75 wt.-%, of an adhesion promoter (AP), and
d) 5.0 to 50.0 wt.-%, preferably 10.0 to 50.0 wt.-%, more preferably 20.0 to 45.0 wt.-%, even more preferably 30.0 to 40.0 wt.-%, like in the range of 32.5 to 37.5 wt.-%, of a heterophasic polypropylene copolymer (HECO),
e) 0.01 to 5.0 wt.-%, preferably 0.1 to 4.0 wt.-%, more preferably 0.1 to 3.0 wt.-%, even more preferably 0.5 to 2.5 wt. %, like in the range of 1.0 to 2.0 wt.-%, of additive (AD),
based on the overall weight of the fiber reinforced composition (C), and wherein components a) to e) add up to 100 wt.-%.

Preferably, the fiber reinforced composition (C) of the invention does not comprise further polymer(s) different to the propylene random copolymer (P), the heterophasic polypropylene copolymer (HECO), and the adhesion promoter (AP) in an amount exceeding 5.0 wt.-%, preferably in an amount exceeding 3.0 wt.-%, more preferably in an amount exceeding 2.5 wt.-%, based on the overall weight of the fiber reinforced composition (C). One additional polymer which may be present in such low amounts is a polyethylene which is a reaction by-product obtained by the preparation of the heterophasic polypropylene copolymer (HECO).

The fiber reinforced composition (C) has a melt flow rate MFR₂ (230° C., 2.16 kg) determined according to ISO 1133 in the range of 10.0 to 100.0 g/10 min, preferably in the range of 12.0 to 80.0 g/10 min, more preferably in the range of 14.0 to 70.0 g/10 min, and even more preferably 15.0 to 60.0 g/10 min.

The fiber reinforced composition (C) has a melting temperature determined by differential scanning calorimetry (DSC) equal or below 155° C., preferably in the range of 125 to 150° C., more preferably in the range of 130 to 145° C., like in the range of 132 to 142° C.

Regarding the mechanical properties, it is preferred that the fiber reinforced composition (C) has tensile modulus determined according to ISO 527-1A in the range of 2500 to 6000 MPa, more preferably in the range of 2800 to 5500 MPa, even more preferably in the range of 3200 to 5200 MPa, like in the range of 4000 to 5000 MPa. Furthermore, the fiber reinforced composition (C) preferably has a tensile strength determined according to ISO 527-2 in the range of 40 to 100 MPa, preferably 50 to 90 MPa, more preferably in the range of 60 to 90 MPa, like in the range of 70 to 80 MPa.

Additionally or alternatively to the previous paragraph, it is preferred that the fiber reinforced composition (C) has a Charpy unnotched impact strength determined according to ISO 179 1 eU at 23° C. of at least 30.0 kJ/m², more preferably at least 35.0 kJ/m², still more preferably 40.0 kJ/m², even more preferably at least 45 kJ/m², and most preferably of at least 50.0 kJ/m². A reasonable upper limit for the Charpy unnotched impact strength determined according to ISO 179 1 eU at 23° C. can be 100 kJ/m².

Moreover, it is preferred that the fiber reinforced composition (C) has a heat deflection temperature (HDT) determined according to ISO 75 A of at least 125° C., more preferably at least 130° C., still more preferably at least 135° C., yet even more preferably at least 140° C., like at least 145° C. A reasonable upper limit for the heat deflection temperature (HDT) determined according to ISO 75 A can be 160° C.

Further, it is preferred that the fiber reinforced composition (C) comprises a low amount of volatile compounds (VOC) as determined according to VDA 278 of below 45 μg/g, more preferably below 35 μg/g, still more preferably below 30 μg/g, yet even more preferably below 25 μg/g, like below 15 μg/g.

Likewise, it is preferred that the fiber reinforced composition (C) comprises a low amount of medium volatile compounds (FOG) as determined according to VDA 278 of below 100 μg/g, more preferably below 90 μg/g, still more preferably below 85 μg/g, yet even more preferably below 80 μg/g.

According to one particularly preferred embodiment, the fiber reinforced composition (C) has:
(i) a melt flow rate MFR₂ (230° C., 2.16 kg) determined according to ISO 1133 in the range of 10.0 to 100.0 g/10 min, preferably in the range of 12.0 to 80.0 g/10 min, more preferably in the range of 14.0 to 70.0 g/10 min, and even more preferably 15.0 to 60.0 g/10 min;
(ii) a tensile modulus determined according to ISO 527-1A in the range of 2500 to 6000 MPa, more preferably in the range of 2800 to 5500 MPa, even more preferably in the range of 3200 to 5200 MPa, like in the range of 4000 to 5000 MPa;
(iii) a Charpy unnotched impact strength determined according to ISO 179 1 eU at 23° C. of at least 30.0 kJ/m², more preferably at least 35.0 kJ/m², still more preferably 40.0 kJ/m², even more preferably at least 45 kJ/m², and most preferably of at least 50.0 kJ/m²;
(iv) a heat deflection temperature (HDT) determined according to ISO 75 A of at least 125° C., more preferably at least 130° C., still more preferably at least 135° C., yet even more preferably at least 140° C., like at least 145° C.; and
(v) an amount of volatile compounds (VOC) as determined according to VDA 278 of below 45 μg/g, more preferably below 35 μg/g, still more preferably below 30 μg/g, yet even more preferably below 25 μg/g, like below 15 μg/g.

The fiber reinforced composition (C) is preferably obtained by melt blending the propylene random copolymer (P), the glass fibers (GF), the heterophasic polypropylene copolymer (HECO), the adhesion promoter (AP) and optionally the additives (AD). Such melt blending processes are well-known in the art.

In the following, the components of the fiber reinforced composition (C) are described in more detail.

### The Propylene Random Copolymer (P)

The fiber reinforced composition (C) comprises a propylene random copolymer (P). The propylene random copolymer (P) is present in the composition (C) in an amount of 20.0 to 89.9 wt.-%, preferably 25.0 to 79.5 wt.-%, more preferably 30.0 to 64.0 wt.-%, and even more preferably 35.0 to 54.0 wt. %, like in the range of 38.25 to 48.75 wt.-%, based on the overall weight of the composition (C).

The propylene random copolymer (P) is a copolymer of propylene and at least one comonomer selected from C₄ to C₁₂ α-olefins. Accordingly, the propylene random copolymer (P) comprises monomers copolymerizable with propylene selected from C₄ to C₁₂ α-olefins. Preferably, the comonomer(s) is (are) selected from C₄ to C₆ α-olefins, e.g. 1-butene and/or 1-hexene. It is preferred that the propylene random copolymer according to one embodiment of the invention comprises, more preferably consists of, propylene and monomers copolymerizable with propylene selected from the group consisting of 1-butene and 1-hexene. More specifically, the propylene random copolymer (P) of this invention comprises—apart from propylene—units derivable from 1-butene and/or 1-hexene. Hence, according to one preferred embodiment, the propylene random copolymer (P) is a copolymer of propylene and at least one comonomer selected from 1-butene and 1-hexene.

According to one embodiment, the comonomer is 1-hexene. Therefore, the propylene random copolymer (P) can comprise units derivable from propylene and 1-hexene only. In other words, in one embodiment, only propylene and 1-hexene have been polymerized.

According to one particularly preferred embodiment, the propylene random copolymer (P) is a copolymer of propylene and 1-butene.

The term “random copolymer” can preferably be understood according to IUPAC (Pure Appl. Chem., Vol. No. 68, 8, pp. 1591 to 1595, 1996). Preferably the molar concentration of comonomer dyads, like 1-hexene and/or 1-butene dyads, obeys the relationship

[HH]<[H]²
wherein
[HH] is the molar fraction of adjacent comonomer units, like of adjacent 1-hexene and/or 1-butene units, and
[H] is the molar fraction of total comonomer units, like of total 1-hexene and/or 1-butene units, in the polymer.

Preferably, the propylene random copolymer (P) has a comonomer content, like a 1-butene content, in the range of 2.5 to 10.0 mol-%, more preferably in the range of 3.0 to 8.0 mol-%, even more preferably of 3.5 to 7.5 mol-%, yet even more preferably of 4.0 to 7.0 mol-%, still more preferably of 4.5 to 6.5 mol-%, like in the range of 5.0 to 6.0 mol-%.

Further, it is preferred that the propylene random copolymer (P) is bimodal.

In particular, it is preferred that the propylene random copolymer (P) comprises
i) a first propylene random copolymer (P1), and
ii) a second propylene random copolymer (P2) having a higher comonomer content, preferably 1-butene content, than the first propylene random copolymer (P1),
wherein the combined amount of the first propylene random copolymer (P1) and the second propylene random copolymer (P2) based on the propylene random copolymer (P) is at least 95.0 wt.-%, more preferably 97.0 wt.-%, still more preferably 99.0 wt.-%, like 99.9 wt.-%. It is especially preferred that the random propylene copolymer essentially consists of, preferably consists of the first propylene random copolymer (P1) and the second propylene random copolymer (P2). Regarding the term “random copolymer”, reference is made to the definition provided above.

Preferably, the weight ratio between the first propylene random copolymer (P1) and the second propylene random copolymer (P2) is in the range of 20/80 to 70/30, more preferably in the range of 30/70 to 60/40, still more preferably in the range of 45/55 to 55/45.

According to one embodiment of the present invention, the propylene random copolymer (P) comprises
i) a first propylene random copolymer (P1), and
ii) a second propylene random copolymer (P2) having a higher comonomer content than the first propylene random copolymer (P1),
wherein the weight ratio between the first propylene random copolymer (P1) and the second propylene random copolymer (P2) is in the range of 20/80 to 60/40, more preferably 30/70 to 60/40, still more preferably in the range of 45/55 to 55/45, and the combined amount of the first propylene random copolymer (P1) and the second propylene random copolymer (P2) is at least 95.0 wt.-%, more preferably 97.0 wt.-%, still more preferably 99.0 wt.-%, like 99.9 wt.-%, based on the propylene random copolymer (P).

In this embodiment, the second propylene random copolymer (P2) has a higher comonomer content, like 1-butene content, than the first propylene random copolymer (P1). Preferably, the ratio C (P2)/C (P1) is in the range of 1.1 to 10.0, more preferably in the range of 1.2 to 5.0, still more preferably in the range of 1.2 to 3.0, yet even more preferably in the range of 1.2 to 2.0, like in the range of 1.3 to 1.8, wherein C (P2) is the comonomer content, preferably 1-butene content, in [mol-%] of the second propylene random copolymer (P2) and C (P1) is the comonomer content, preferably 1-butene content, in [mol-%] of the first propylene random copolymer (P2).

It is preferred that the first propylene random copolymer (P1) has a comonomer content, preferably 1-butene content, in the range of 2.0 to 6.0 mol-%, more preferably in the range of 3.0 to 5.5 mol-%, still more preferably in the range of 3.5 to 5.5 mol-%, yet even more preferably of from 4.0 to 5.0 mol-%.

The second propylene random copolymer (P2) preferably has a comonomer content, preferably 1-butene content, in the range of 4.0 to 14.0 mol-%, more preferably in the range of 5.0 to 10.0 mol-%, still more preferably in the range of 5.5 to 8.0 mol-%, and yet even more preferably in the range of 6.0 to 7.0 mol-%.

According to one embodiment, the propylene random copolymer (P) comprises
i) a first propylene random copolymer (P1) having a comonomer content in the range of 2.0 to 6.0 mol-%, preferably in the range of 3.0 to 5.5 mol-%, more preferably in the range of 3.5 to 5.5 mol-%, and yet even more preferably of from 4.0 to 5.0 mol-%, and
ii) a second propylene random copolymer (P2) having a comonomer content in the range of 4.0 to 14.0 mol-%, preferably in the range of 5.0 to 10.0 mol-%, more preferably in the range of 5.5 to 8.0 mol-%, and yet even more preferably in the range of 6.0 to 7.0 mol-%,
   wherein the comonomer content of the second propylene random copolymer (P2) is higher than the comonomer content of the first propylene random copolymer (P1).

The propylene random copolymer (P) has an amount of 1,2 erythro regio-defects in the range of 0.4 to 1.2 mol-%. Without being bound to theory, a high amount of misinsertions of propylene and/or the polymerized comonomer, like 1-butene, within the polymer chain indicates that the propylene random copolymer (P) is produced in the presence of a single site catalyst, preferably a metallocene catalyst. It is known in the art that propylene random copolymers which are produced in the presence of a Ziegler-Natta catalyst can have an amount of 1,2 erythro regio-defects of well below 0.4 mol-%, and are often essentially free of 1,2 erythro regio-defects.

Preferably, the propylene random copolymer (P) has a melt flow rate MFR₂ (230° C., 2.16 kg) determined according to ISO 1133 in the range of 45.0 to 150 g/10 min, preferably in the range of 55.0 to 130 g/10 min, more preferably in the range of 65.0 to 120 g/10 min, still more preferably in the range of 70.0 to 110 g/10 min, like in the range of 80.0 to 100 g/10 min. Hence, it is preferred that the propylene random copolymer (P) according to the present invention has a rather high melt flow rate.

In this regard, it may be that the propylene random copolymer (P) is visbroken. It is however preferred that the propylene random copolymer (P) is not visbroken.

The melting temperature Tm determined according to differential scanning calorimetry (DSC) of the propylene random copolymer (P) is preferably in the range of 125 to 150° C., more preferably in the range of 128 to 145° C., even more preferably in the range of 132 to 145° C., still more preferably in the range of 135 to 145° C., like in the range of 138 to 142° C.

The propylene random copolymer (P) can be further characterized by its amount of xylene cold solubles (XCS). According to one preferred embodiment of the present invention, the propylene random copolymer (P) has a xylene soluble content (XCS) determined according to ISO 16152 (25° C.) in the range of 0.1 to 5.0 wt.-%, preferably in the range of 0.2 to 3.0 wt.-%, more preferably in the range of 0.3 to 2.0 wt.-%, like in the range of 0.3 to 1.0 wt.-%, based on the overall weight of the propylene random copolymer (P).

The low amount of xylene cold solubles (XCS) also indicates that the propylene random copolymer (P) preferably does not contain elastomeric (co) polymers forming inclusions as a second phase for improving mechanical properties. The presence of second phases or the so called inclusions are for instance visible by high resolution microscopy, like electron microscopy or atomic force microscopy, or by dynamic mechanical thermal analysis (DMTA).

The propylene random copolymer (P) has a glass transition temperature of above −30° C., e.g. above −25° C., e.g. above −20° C. It is preferred that the propylene random copolymer (P) has a glass transition temperature of above −10° C., like in the range of −5 to 0° C.

The propylene random copolymer (P) can be obtainable, preferably obtained, by a process as defined in detail below.

The process for the preparation of the propylene random copolymer (P) is preferably a sequential polymerization process comprising at least two reactors connected in series (e.g. two reactors in series), wherein said process comprises the steps of
(A) polymerizing in a first reactor (R-1) being a slurry reactor (SR), preferably a loop reactor (LR), propylene and a comonomer selected from C4 to C12 α-olefins, preferably 1-butene, obtaining a first propylene random copolymer (P1) as defined in the instant invention,
(B) transferring said first propylene random copolymer (P1) and unreacted comonomers of the first reactor (R-1) in a second reactor (R-2) being a gas phase reactor (GPR-1),
(C) feeding to said second reactor (R-2) propylene and a comonomer selected from C4 to C12 α-olefins, preferably 1-butene,
(D) polymerizing in said second reactor (R-2) and in the presence of said first propylene random copolymer (P1) propylene and a comonomer selected from C4 to C12 α-olefins, preferably 1-butene, obtaining a second propylene random copolymer (P2) as defined in the instant invention, said first propylene random copolymer (P1) and said second propylene random copolymer (P2) form the propylene random copolymer (P) as defined in the instant invention, wherein further in the first reactor (R-1) and second reactor (R-2) the polymerization preferably takes place in the presence of a solid catalyst system (SCS) comprising
(i) a transition metal compound of formula (I)

Rₙ(Cp)₂MX₂ (I)
wherein
“M” is a transition metal of Group 4, e.g. zirconium (Zr) or hafnium (Hf),
each “X” is independently a monovalent anionic σ-ligand,
each “Cp” is a cyclopentadienyl-type organic ligand independently selected from the group consisting of unsubstituted or substituted and/or fused cyclopentadienyl, substituted or unsubstituted indenyl or substituted or unsubstituted fluorenyl, said organic ligands coordinate to the transition metal (M),
“R” is a bivalent bridging group linking said organic ligands (Cp),
“n” is 1 or 2, preferably 1, and
(ii) optionally a cocatalyst (Co) comprising an element (E) of group 13 of the periodic table (IUPAC), preferably a cocatalyst (Co) comprising a compound of Al and/or B.

Concerning the definition of the propylene random copolymer (P), first random propylene copolymer (P1) and second random propylene copolymer (P2), reference is made to the definitions given above.

The solid catalyst system (SCS) is defined in more detail below.

Due to the use of the solid catalyst system (SCS) in a sequential polymerization process the manufacture of the above defined propylene random copolymer (P) is possible. In particular due to the preparation of a propylene copolymer, i.e. the first random propylene copolymer (P1), in the first reactor (R-1) and the conveyance of said propylene copolymer and especially the conveyance of unreacted comonomers into the second reactor (R-2) it is possible to produce a copolymer (P) with high comonomer content in a sequential polymerization process. Normally the preparation of a propylene copolymer with high comonomer content in a sequential polymerization process leads to fouling or in severe cases to the blocking of the transfer lines as normally unreacted comonomers condensate at the transfer lines. However with the method described herein the conversion of the comonomers is increased and therewith a better incorporation into the polymer chain leading to higher comonomer content and reduced stickiness problems can be achieved.

The term “sequential polymerization process” indicates that the propylene random copolymer (P) is produced in at least two reactors connected in series. More precisely the term “sequential polymerization process” indicates in the present application that the polymer of the first reactor (R-1) is directly conveyed with unreacted comonomers to the second reactor (R-2). Accordingly the decisive aspect of the present process is the preparation of the propylene random copolymer (P) in two different reactors, wherein the reaction material of the first reactor (R-1) is directly conveyed to the second reactor (R-2). Thus the present process comprises at least a first reactor (R-1) and a second reactor (R-2). In one specific embodiment the instant process consists of two polymerization reactors (R-1) and (R-2). The term “polymerization reactor” shall indicate that the main polymerization takes place there. Thus in case the process consists of two polymerization reactors, this definition does not exclude the option that the overall process comprises for instance a pre-polymerization step in a pre-polymerization reactor. The term “consists of” is only a closing formulation in view of the main polymerization reactors.

The first reactor (R-1) is a slurry reactor (SR), and in particular can be any continuous or simple stirred batch tank reactor or loop reactor operating in slurry. The slurry reactor (SR) is preferably a loop reactor (LR).

The second reactor (R-2) and any subsequent reactors are gas phase reactors (GPR). Such gas phase reactors (GPR) can be any mechanically mixed or fluid bed reactors. Preferably the gas phase reactor(s) (GPR) comprise a mechanically agitated fluid bed reactor with gas velocities of at least 0.2 m/sec. Thus it is appreciated that the gas phase reactor (GPR) is a fluidized bed type reactor preferably with a mechanical stirrer.

The condition (temperature, pressure, reaction time, monomer feed) in each reactor is dependent on the desired product which is in the knowledge of a person skilled in the art. As already indicated above, the first reactor (R-1) is a slurry reactor (SR), like a loop reactor (LR), whereas the second reactor (R-2) is a gas phase reactor (GPR-1). The subsequent reactors—if present—are also gas phase reactors (GPR).

A preferred multistage process is a “loop-gas phase”-process, such as developed by Borealis A/S, Denmark (known as BORSTAR® technology) described e.g. in patent literature, such as in EP 0 887 379 or in WO 92/12182.

Multimodal polymers can be produced according to several processes which are described, e.g. in WO 92/12182, EP 0 887 379, and WO 98/58976. The contents of these documents are included herein by reference.

Preferably, in the instant process for producing the propylene random copolymer (P) as defined above the conditions for the first reactor (R-1), i.e. the slurry reactor (SR), like a loop reactor (LR), of step (A) may be as follows:
the temperature is within the range of 40° C. to 110° C., preferably between 60° C. and 100° C., more preferably in the range of 65 to 90° C.,
the pressure is within the range of 20 bar to 80 bar, preferably between 40 bar and 70 bar,
hydrogen can be added for controlling the molar mass in a manner known per se.

Subsequently, the reaction mixture from step (A) is transferred to the second reactor (R-2), i.e. gas phase reactor (GPR-1), i.e. to step (D), whereby the conditions in step (D) are preferably as follows:
the temperature is within the range of 50° C. to 130° C., preferably between 60° C. and 100° C.,
the pressure is within the range of 5 bar to 50 bar, preferably between 15 bar to 40 bar,
hydrogen can be added for controlling the molar mass in a manner known per se.

The residence time can vary in both reactor zones.

In one embodiment of the process for producing the propylene random copolymer (P) the residence time in the slurry reactor (SR), e.g. loop (LR) is in the range 0.2 to 4.0 hours, e.g. 0.3 to 1.5 hours or 0.2 to 1.0 hours, and the residence time in the gas phase reactor (GPR) will generally be 0.2 to 6.0 hours, e.g. 0.2 to 4.0 hours or 0.2 to 1.0 hours.

If desired, the polymerization may be effected in a known manner under supercritical conditions in the first reactor (R-1), i.e. in the slurry reactor (SR), like in the loop reactor (LR).

The conditions in the other gas phase reactors (GPR), if present, are similar to the second reactor (R-2).

The present process may also encompass a pre-polymerization prior to the polymerization in the first reactor (R-1). The pre-polymerization can be conducted in the first reactor (R-1), however it is preferred that the pre-polymerization takes place in a separate reactor, a so called pre-polymerization reactor.

The propylene random copolymer (P) as defined herein is preferably prepared in the presence of a solid catalyst system (SCS) comprising
(i) a transition metal compound of formula (I)

Rₙ(Cp)₂MX₂ (I)
wherein
“M” is a transition metal of Group 4, e.g. zirconium (Zr) or hafnium (Hf),
each “X” is independently a monovalent anionic σ-ligand,
each “Cp” is a cyclopentadienyl-type organic ligand independently selected
from the group consisting of unsubstituted or substituted and/or fused cyclopentadienyl, substituted or unsubstituted indenyl or substituted or unsubstituted fluorenyl, said organic ligands coordinate to the transition metal (M),
“R” is a bivalent bridging group linking said organic ligands (Cp),
“n” is 1 or 2, preferably 1, and
(ii) optionally a cocatalyst (Co) comprising an element (E) of group 13 of the periodic table (IUPAC), preferably a cocatalyst (Co) comprising a compound of Al and/or B.

The propylene random copolymer (P) as defined herein is preferably prepared in the presence of a solid catalyst system (SCS) comprising a metallocene compound. “Metallocene compound” in the meaning of the present invention can be understood in a broad sense as a compound comprising a metal, preferably transition metal, which is bound to two cyclopentadienyl-containing and/or cyclopentadienyl anion-containing ligands.

According to one embodiment, the metallocene compound comprises titanium, zirconium or hafnium, and preferably zirconium or hafnium, and more preferably zirconium.

Preferably, the solid catalyst system (SCS) comprises (i) a metallocene compound of formula (I):

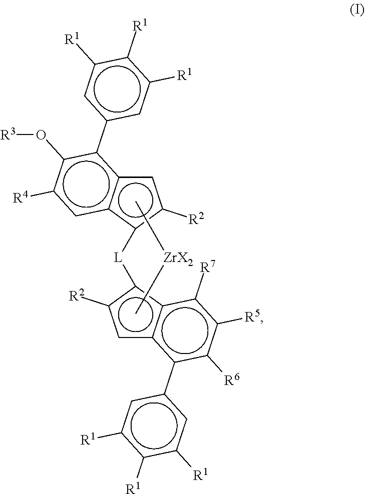

each X independently is a sigma-donor ligand,
L is a divalent bridge selected from —R′₂C—, —R′₂C—CR′₂—, —R′₂Si—, —R′₂Si—SiR′₂—, —R′₂Ge—, wherein
each R′ is independently a hydrogen atom or a C₁-C₂₀-hydrocarbyl group optionally containing one or more heteroatoms of Group 14-16 of the periodic table or fluorine atoms, or optionally two R′ groups taken together form a ring,
each R¹ are independently the same or different, and are hydrogen, a linear or branched C₁-C₆-alkyl group, a C₇₋₂₀ arylalkyl, C₇₋₂₀ alkylaryl group or C₆₋₂₀ aryl group or an OY group,
wherein Y is a C₁₋₁₀ hydrocarbyl group, and optionally two adjacent R¹ groups are part of a ring including the phenyl carbons to which they are bonded,
each R² independently are the same or different, and are a CH₂—R⁸ group, with R⁸ being H or linear or branched C₁₋₆-alkyl group, C₃₋₈ cycloalkyl group, C₆₋₁₀ aryl group,
R³ is a linear or branched C₁-C₆-alkyl group, C₇₋₂₀ arylalkyl, C₇₋₂₀ alkylaryl group or C₆-C₂₀-aryl group,
R⁴ is a C(R⁹)₃ group, with R⁹ being a linear or branched C₁-C₆ alkyl group,
R⁵ is hydrogen or an aliphatic C₁-C₂₀ hydrocarbyl group optionally containing one or more heteroatoms from groups 14-16 of the periodic table of elements;
R⁶ is hydrogen or an aliphatic C₁-C₂₀ hydrocarbyl group optionally containing one or more heteroatoms from groups 14-16 of the periodic table of elements; or
R⁵ and R⁶ are optionally taken together to form a 5 membered saturated carbon ring which is optionally substituted by n groups R¹⁰, n being from 0 to 4;
each R¹⁰ is same or different, and may be a C₁-C₂₀ hydrocarbyl group, or a C₁-C₂₀ hydrocarbyl radical optionally containing one or more heteroatoms belonging to groups 14-16 of the periodic table of elements;
R⁷ is H or a linear or branched C₁-C₆-alkyl group or an aryl or heteroaryl group having 6 to 20 carbon atoms optionally substituted by one to 3 groups R¹,
(ii) a cocatalyst system comprising a boron containing cocatalyst and/or an aluminoxane cocatalyst and
(iii) optionally a silica support.

Each X independently is a sigma-donor ligand, thus each X may be the same or different, and is preferably a hydrogen atom, a halogen atom, a linear or branched, cyclic or acyclic C₁₋₂₀-alkyl or -alkoxy group, a C₆₋₂₀-aryl group, a C₇₋₂₀-alkylaryl group or a C₇₋₂₀-arylalkyl group; optionally containing one or more heteroatoms of Group 14-16 of the periodic table. The term “C₁₋₂₀ hydrocarbyl group” includes C₁₋₂₀-alkyl, C₂₋₂₀-alkenyl, C₂₋₂₀-alkynyl, C₃₋₂₀-cycloalkyl, C₃₋₂₀-cycloalkenyl, C₆₋₂₀-aryl groups, C₇₋₂₀-alkylaryl groups or C₇₋₂₀-arylalkyl groups or of course mixtures of these groups such as cycloalkyl substituted by alkyl. Linear and branched hydrocarbyl groups cannot contain cyclic units. Aliphatic hydrocarbyl groups cannot contain aryl rings.

Unless otherwise stated, preferred C₁₋₂₀ hydrocarbyl groups are C₁₋₂₀ alkyl, C₄₋₂₀ cycloalkyl, C₅₋₂₀ cycloalkyl-alkyl groups, C₇₋₂₀ alkylaryl groups, C₇₋₂₀ arylalkyl groups or C₆₋₂₀ aryl groups, especially C₁₋₁₀ alkyl groups, C₆₋₁₀ aryl groups, or C₇₋₁₂ arylalkyl groups, e.g. C₁₋₈ alkyl groups. Most especially preferred hydrocarbyl groups are methyl, ethyl, propyl, isopropyl, tert-butyl, isobutyl, C₅₋₆-cycloalkyl, cyclohexylmethyl, phenyl or benzyl. The term “halo” includes fluoro, chloro, bromo and iodo groups, especially chloro or fluoro groups, when relating to the complex definition.

Any group including “one or more heteroatoms belonging to groups 14-16 of the periodic table of elements” preferably means O, S or N. N groups may present as —NH— or —NR″— where R″ is C1-C10 alkyl. There may, for example, be 1 to 4 heteroatoms. The group including one or more heteroatoms belonging to groups 14-16 of the periodic table of elements may also be an alkoxy group, e.g. a C₁-C₁₀-alkoxy group.

Preferred complexes for the preparation of the propylene random copolymer are for example described in WO2019179959.

More preferred metallocene compounds are of formula (II)

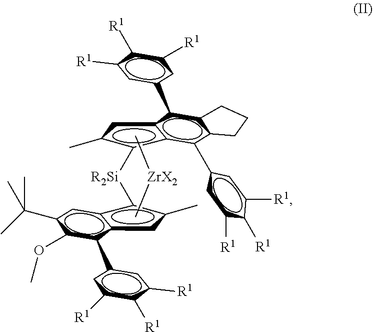

wherein each R¹ are independently the same or different, and are hydrogen or a linear or branched C₁-C₆-alkyl group, whereby at least on R¹ per phenyl group is not hydrogen,
R′ is a C₁₋₁₀ hydrocarbyl group, preferably a C₁₋₄ hydrocarbyl group and more preferably a methyl group, and
X independently is a hydrogen atom, a halogen atom, C₁₋₆ alkoxy group, C₁₋₆ alkyl group, phenyl or benzyl group.

Most preferably, X is chlorine, benzyl or a methyl group. Preferably, both X groups are the same. The most preferred options are two chlorides, two methyl or two benzyl groups, especially two chlorides.

Specific preferred metallocene compounds include:
rac-anti-dimethylsilanediyl [2-methyl-4,8-bis-(4′-tert-butylphenyl)-1,5,6,7-tetrahydro-s-indacen-1-yl] [2-methyl-4-(3′,5′-dimethyl-phenyl)-5-methoxy-6-tert-butylinden-1-yl]zirconium dichloride
rac-anti-dimethylsilanediyl [2-methyl-4,8-bis-(3′,5′-dimethylphenyl)-1,5,6,7-tetrahydro-s indacen-1-yl] [2-methyl-4-(3′,5′-dimethylphenyl)-5-methoxy-6-tert-butylinden-1-yl]zirconium dichloride
rac-anti-dimethylsilanediyl [2-methyl-4,8-bis-(3′,5′-dimethylphenyl)-1,5,6,7-tetrahydro-s-indacen-1-yl] [2-methyl-4-(3′,5′-ditert-butyl-phenyl)-5-methoxy-6-tert-butylinden-1-yl]zirconium dichloride
   or their corresponding zirconium dimethyl analogues.

The ligands required to form the complexes and hence catalysts can be synthesized by any process and the skilled organic chemist would be able to devise various synthetic protocols for the manufacture of the necessary ligand materials. For Example WO2007/116034 discloses the necessary chemistry. Synthetic protocols can also generally be found in WO2002/02576, WO2011/135004, WO2012/084961, WO2012/001052, WO2011/076780, WO2015/158790 and WO2018/122134. The examples section also provides the skilled person with sufficient direction.

### Cocatalyst

To form an active catalytic species it is normally necessary to employ a cocatalyst as is well known in the art. A cocatalyst system comprising a boron containing cocatalyst and/or an aluminoxane cocatalyst can be used in combination with the above defined metallocene compound.

The aluminoxane cocatalyst can be one of formula (III):

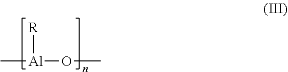

where n is usually from 6 to 20 and R has the meaning below.

Aluminoxanes are formed on partial hydrolysis of organoaluminum compounds, for example those of the formula AlR₃, AlR₂Y and Al₂R₃Y₃ where R can be, for example, C₁-C₁₀ alkyl, preferably C₁-C₅ alkyl, or C₃₋₁₀ cycloalkyl, C₇-C₁₂ arylalkyl or alkylaryl and/or phenyl or naphthyl, and where Y can be hydrogen, halogen, preferably chlorine or bromine, or C1-C10 alkoxy, preferably methoxy or ethoxy. The resulting oxygen-containing aluminoxanes are not in general pure compounds but mixtures of oligomers of the formula (III).

The preferred aluminoxane is methylaluminoxane (MAO). Since the aluminoxanes described herein as cocatalysts are not, owing to their mode of preparation, pure compounds, the molarity of aluminoxane solutions hereinafter is based on their aluminium content.

Also a boron containing cocatalyst can be used instead of the aluminoxane cocatalyst or the aluminoxane cocatalyst can be used in combination with a boron containing cocatalyst.

It will be appreciated by the skilled man that where boron based cocatalysts are employed, it is normal to pre-alkylate the complex by reaction thereof with an aluminium alkyl compound, such as TIBA. This procedure is well known and any suitable aluminium alkyl, e.g. Al(C₁₋₆-alkyl)₃. can be used. Preferred aluminium alkyl compounds are triethylaluminium, tri-isobutylaluminium, tri-isohexylaluminium, tri-n-octylaluminium and tri-isooctylaluminium.

Alternatively, when a borate cocatalyst is used, the metallocene compound is in its alkylated version, that is for example a dimethyl or dibenzyl metallocene compound can be used. Boron based cocatalysts of interest include those of formula (IV)

BY₃ (IV)
wherein Y is the same or different and is a hydrogen atom, an alkyl group of from 1 to about 20 carbon atoms, an aryl group of from 6 to about 15 carbon atoms, alkylaryl, arylalkyl, haloalkyl or haloaryl each having from 1 to 10 carbon atoms in the alkyl radical and from 6-20 carbon atoms in the aryl radical or fluorine, chlorine, bromine or iodine. Preferred examples for Y are methyl, propyl, isopropyl, isobutyl or trifluoromethyl, unsaturated groups such as aryl or haloaryl like phenyl, tolyl, benzyl groups, p-fluorophenyl, 3,5-difluorophenyl, pentachlorophenyl, pentafluorophenyl, 3,4,5-trifluorophenyl and 3,5-di(trifluoromethyl)phenyl. Preferred options are trifluoroborane, triphenylborane, tris(4-fluorophenyl) borane, tris(3,5-difluorophenyl) borane, tris(4-fluoromethylphenyl) borane, tris(2,4,6-trifluorophenyl) borane, tris(penta-fluorophenyl) borane, tris(tolyl) borane, tris(3,5-dimethyl-phenyl) borane, tris(3,5-difluorophenyl) borane and/or tris(3,4,5-trifluorophenyl) borane.

Particular preference is given to tris(pentafluorophenyl) borane.

However it is preferred that borates are used, i.e. compounds containing a borate 3+ ion. Such ionic cocatalysts preferably contain a non-coordinating anion such as tetrakis(pentafluorophenyl) borate and tetraphenylborate. Suitable counterions are protonated amine or aniline derivatives such as methylammonium, anilinium, dimethylammonium, diethylammonium, N-methylanilinium, diphenylammonium, N,N-dimethylanilinium, trimethylammonium, triethylammonium, tri-n-butylammonium, methyldiphenylammonium, pyridinium, p-bromo-N,N-dimethylanilinium or p-nitro-N, N-dimethylanilinium.

Preferred ionic compounds which can be used include: triethylammoniumtetra(phenyl)borate, tributylammoniumtetra(phenyl)borate, trimethylammoniumtetra(tolyl)borate, tributylammoniumtetra(tolyl)borate, tributylammoniumtetra(pentafluorophenyl)borate, tripropylammoniumtetra(dimethylphenyl)borate, tributylammoniumtetra(trifluoromethylphenyl)borate, tributylammoniumtetra(4-fluorophenyl)borate, N,N-dimethylcyclohexylammoniumtetrakis(pentafluorophenyl)borate, N,N-dimethylbenzylammoniumtetrakis(pentafluorophenyl)borate, N,N-dimethylaniliniumtetra(phenyl)borate, N, N-diethylaniliniumtetra(phenyl) borate, N,N-dimethylaniliniumtetrakis(pentafluorophenyl)borate, N,N-di(propyl)ammoniumtetrakis(pentafluorophenyl)borate, di(cyclohexyl)ammoniumtetrakist(pentafluorophenyl)borate, triphenylphosphoniumtetrakis(phenyl)borate, triethylphosphoniumtetrakis(phenyl)borate, diphenylphosphoniumtetrakis(phenyl)borate, tri(methylphenyl)phosphoniumtetrakis(phenyl)borate, tri(dimethylphenyl)phosphoniumtetrakis(phenyl)borate, triphenylcarbeniumtetrakis(pentafluorophenyl)borate, or ferroceniumtetrakis(pentafluorophenyl)borate.

Preference is given to triphenylcarbeniumtetrakis(pentafluorophenyl) borate, N,N-dimethylcyclohexylammoniumtetrakis(pentafluorophenyl) borate or N,N-dimethylbenzylammoniumtetrakis(pentafluorophenyl) borate.

Certain boron cocatalysts are especially preferred. Preferred borates comprise the trityl ion. Thus the use of N,N-dimethylammonium-tetrakispentafluorophenylborate and Ph₃CB(PhF₅)₄ and analogues therefore are especially favoured.

According to the present invention, the preferred cocatalysts are alumoxanes, more preferably methylalumoxanes, combinations of alumoxanes with Al-alkyls, boron or borate cocatalysts, and combination of alumoxanes with boron-based cocatalysts.

Suitable amounts of cocatalyst will be well known to the skilled man.

The molar ratio of boron to the metal ion of the metallocene may be in the range 0.5:1 to 10:1 mol/mol, preferably 1:1 to 10:1, especially 1:1 to 5:1 mol/mol.

The molar ratio of Al in the aluminoxane to the metal ion of the metallocene may be in the range 1:1 to 2000:1 mol/mol, preferably 10:1 to 1000:1, and more preferably 50:1 to 500:1 mol/mol.

The catalyst can be used in supported or unsupported form, preferably in supported form. The particulate support material used is preferably an organic or inorganic material, such as silica, alumina or zirconia or a mixed oxide such as silica-alumina, in particular silica, alumina or silica-alumina. The use of a silica support is preferred. The skilled person is aware of the procedures required to support a metallocene catalyst.

Especially preferably, the support is a porous material so that the complex may be loaded into the pores of the support, e.g. using a process analogous to those described in WO94/14856 (Mobil), WO95/12622 (Borealis) and WO2006/097497.

### The Glass Fibers (GF)

The fiber reinforced composition (C) comprises glass fibers (GF). The glass fibers (GF) are present in the fiber reinforced composition (C) in an amount of 5.0 to 45.0 wt.-%, preferably 10.0 to 40.0 wt.-%, more preferably 15.0 to 35.0 wt.-%, even more preferably 15.0 to 25.0 wt.-%, like in the range of 17.5 to 22.5 wt.-%, based on the overall weight of the composition (C).

The glass fibers (GF) may be short glass fibers (SGF), e.g. cut glass fibers or chopped strands, and/or long glass fibers (LGF), e.g. long glass fibers (LGF) obtained from glass rovings.

It is preferred that the fibers (F) are short glass fibers (SGF). According to one embodiment, the glass fibers (GF) are short glass fibers (SGF), which have an average length of 1.0 to 10.0 mm, preferably in the range of 1.0 to 8.0 mm, more preferably in the range of 1.5 to 7.0 mm, and even more preferably in the range of 2.0 to 6.0 mm.

According to one embodiment, the glass fibers (GF) have an average length of 1.0 to 10.0 mm, preferably in the range of 1.0 to 8.0 mm, more preferably in the range of 1.5 to 7.0 mm, and even more preferably in the range of 2.0 to 6.0 mm.

According to one embodiment, the fiber reinforced composition (C) comprises glass fibers (GF) which are obtained by melt-kneading glass fibers (GF) having an average length of 1.0 to 10.0 mm, preferably in the range of 1.0 to 8.0 mm, more preferably in the range of 1.5 to 7.0 mm, and even more preferably in the range of 2.0 to 6.0 mm, with the random propylene copolymer (P), the heterophasic polypropylene copolymer (HECO), and the adhesion promoter (AD), and the optional additives (AD).

The glass fibers (GF), preferably short glass fibers (SGF), can have an average diameter of from 5 to 20 μm, more preferably from 6 to 18 μm, still more preferably 8 to 16 μm.

Preferably, the glass fibers (GF), more preferably short glass fibers (SGF), have an aspect ratio of 125 to 650, preferably of 150 to 500, more preferably 200 to 450. The aspect ratio is the relation between average length and average diameter of the fibers.

According to one embodiment, the glass fibers (GF) have (i) an average length of 1.0 to 10.0 mm, preferably in the range of 1.0 to 8.0 mm, more preferably in the range of 1.5 to 7.0 mm, and even more preferably in the range of 2.0 to 6.0 mm, and (ii) an average diameter of from 5 to 20 μm, more preferably from 6 to 18 μm, still more preferably 8 to 16 μm.

### The Adhesion Promoter (AP)

The fiber reinforced polypropylene composition (C) further comprises an adhesion promoter (AP). The adhesion promoter (AP) is present in the fiber reinforced composition (C) in an amount of 0.1 to 5.0 wt.-%, preferably 0.5 to 3.0 wt.-%, more preferably 1.0 to 2.5 wt.-%, even more preferably 1.0 to 2.0 wt. %, like in the range of 1.25 to 1.75 wt.-%, based on the overall weight of the composition (C).

The adhesion promoter (AP) is preferably a polar modified propylene homo- or copolymer (PM-PP). The polar modified propylene homo- or copolymer (PM-PP) preferably comprises a low molecular weight compound having reactive polar groups. Modified propylene homopolymers and copolymers, like copolymers of propylene and ethylene or with other α-olefins, e.g. C4 to C10 α-olefins, are most preferred, as they are highly compatible with the propylene random copolymer (P) of the inventive fiber reinforced polypropylene composition (C).

In terms of structure, the polar modified propylene homo- or copolymer (PM-PP) are preferably selected from graft propylene homo- or copolymers. In this context, preference is given to polar modified propylene homo- or copolymers (PM-PP) containing polar groups selected from the group consisting of acid anhydrides, carboxylic acids, carboxylic acid derivatives, primary and secondary amines, hydroxyl compounds, oxazoline and epoxides, ionic compounds, and combinations thereof.

Hence, according to one embodiment, the adhesion promoter (AP) is a polar modified propylene homo- or copolymer (PM-PP) comprising polar groups selected from the group consisting of acid anhydrides, carboxylic acids, carboxylic acid derivatives, primary and secondary amines, hydroxyl compounds, oxazoline and epoxides, ionic compounds, and combinations thereof.

Specific examples of said polar compounds are unsaturated cyclic anhydrides and their aliphatic diesters, and the diacid derivatives. In particular, one can use maleic anhydride and compounds selected from C1 to C10 linear and branched dialkyl maleates, C1 to C10 linear and branched dialkyl fumarates, itaconic anhydride, C1 to C10 linear and branched itaconic acid dialkyl esters, acrylic acid, maleic acid, fumaric acid, itaconic acid and mixtures thereof.

The polar modified propylene homo- or copolymer (PM-PP) can comprise polar groups in an amount from 0.5 to 5.0 wt.-%, based on the total weight of the homo- or copolymer (PM-PP). For example, the amount may be in the range of 0.5 wt.-% to 4.5 wt.-%, preferably in the range of 0.5 wt.-% to 4.0 wt.-%, more preferably in the range of 0.5 wt.-% to 3.5 wt.-%.

Particular preference is given to an adhesion promoter (AP) which is a polar modified propylene homo- or copolymer (PM-PP), wherein the polar modified propylene homo- or copolymer (PM-PP) is a propylene homo- or copolymer grafted with maleic anhydride or acrylic acid. Said adhesion promoter (AP) can be produced in a simple manner by reactive extrusion of the polymer, for example with maleic anhydride or acrylic acid in the presence of free radical generators (like organic peroxides), as disclosed for instance in U.S. Pat. Nos. 4,506,056, 4,753,997 or EP 1 805 238.

Preferred values of the melt flow rate MFR₂ (230° C., 2.16 kg) for the adhesion promoter (AP), preferably the polar modified propylene homo- or copolymer (PM-PP), are from 20.0 to 400 g/10 min. It is particularly preferred that the adhesion promoter (AP), preferably the polar modified propylene homo- or copolymer (PM-PP), has a melt flow rate MFR₂ (230° C.) in the range of 30.0 to 300 g/10 min, and more preferably in the range of 40.0 to 250 g/10 min, like in the range of 40.0 to 100 g/10 min.

In one preferred embodiment of the present invention, the adhesion promoter (AP) is a maleic anhydride modified polypropylene homo- or copolymer and/or an acrylic acid modified polypropylene homo- or copolymer. Preferably, the adhesion promoter (AP) is a maleic anhydride modified polypropylene homopolymer and/or an acrylic acid modified polypropylene homopolymer and preferably a maleic anhydride modified polypropylene homopolymer. For example, suitable polar modified polypropylene (PM-PP) homo- or copolymers include, for example, a polypropylene homopolymer grafted with maleic anhydride (PP-g-MAH) and a polypropylene homopolymer grafted with acrylic acid (PP-g-AA).

According to one preferred embodiment, the adhesion promoter (AP) is a polar modified propylene homo- or copolymer (PM-PP), which is a propylene homo- or copolymer being grafted with maleic anhydride, wherein the adhesion promoter (AP) has a melt flow rate MFR₂ (230° C., 2.16 kg) determined according to ISO 1133 of 20.0 g/10 min to 400 g/10 min.

According to another preferred embodiment of the present invention, the adhesion promoter (AP) is the propylene random copolymer (P) as described above grafted with maleic anhydride.

### The Heterophasic Polypropylene Copolymer (HECO)

The fiber reinforced composition (C) further comprises a heterophasic polypropylene copolymer (HECO). The heterophasic polypropylene copolymer (HECO) is present in the fiber reinforced composition (C) in an amount of 5.0 to 50.0 wt.-%, preferably 10.0 to 50.0 wt.-%, more preferably 20.0 to 45.0 wt.-%, even more preferably 30.0 to 40.0 wt.-%, like in the range of 32.5 to 37.5 wt.-%, based on the overall weight of the composition (C).

The heterophasic polypropylene copolymer (HECO) preferably comprises
i) a matrix being a propylene homopolymer (hPP), and
ii) an elastomeric ethylene copolymer (E) being dispersed in said matrix, wherein the elastomeric ethylene polymer (E) is a copolymer of ethylene and propylene, and optionally at least one comonomer selected from C4 to C12 α-olefins (e.g. 1-butene or 1-hexene).

According to one embodiment, the heterophasic polypropylene copolymer (HECO) comprises
i) a matrix being a propylene homopolymer (hPP), and
ii) an elastomeric ethylene copolymer (E) being dispersed in said matrix, wherein the elastomeric ethylene polymer (E) is a copolymer of ethylene and propylene.

According to one embodiment, the heterophasic polypropylene copolymer (HECO) comprises
i) a matrix being a propylene homopolymer (hPP), and
ii) an elastomeric ethylene copolymer (E) being dispersed in said matrix, wherein the elastomeric ethylene polymer (E) is a copolymer of ethylene and propylene, and at least one comonomer selected from C4 to C12 α-olefins, and preferably selected from 1-butene or 1-hexene.

If an optional at least one comonomer selected from C4 to C12 α-olefins is present in the elastomeric ethylene polymer (E), the at least one comonomer selected from C4 to C12 α-olefins is preferably present in the elastomeric ethylene polymer (E) in a minor amount, which means that the at least one comonomer selected from C4 to C12 α-olefins is present in a weight amount which is below the weight amount of ethylene in the elastomeric ethylene polymer (E). For example, the at least one comonomer selected from C4 to C12 α-olefins can be present in an amount of less than 10.0 wt.-%, preferably less than 5.0 wt.-%, based on the total weight of the elastomeric ethylene polymer (E).

The expression “propylene homopolymer (hPP)” can preferably be understood as a polypropylene that consists substantially, i.e. of at least 99.0 wt.-%, more preferably of at least 99.5 wt.-%, still more preferably of at least 99.8 wt.-%, like of at least 99.9 wt.-%, of propylene units. In another embodiment only propylene units are detectable, i.e. only propylene has been polymerized.

The heterophasic polypropylene copolymer (HECO) preferably has preferably a xylene cold soluble (XCS) content determined at 25° C. according ISO 16152 in the range of 5.0 to 45.0 wt. %, more preferably 10.0 to 42.5 wt.-%, even more preferably 15.0 to 40.0 wt.-%, yet even more preferably 20.0 to 40.0 wt.-%, like in the range of 25.0 to 35.0 wt.-%, based on the overall weight of the heterophasic polypropylene copolymer (HECO).

The heterophasic polypropylene copolymer (HECO) preferably has an ethylene content of the xylene cold soluble (XCS) fraction in the range of 20.0 to 55.0 wt. %, more preferably in the range of 22.5 to 50.0 wt.-%, even more preferably in the range of 25.0 to 45.0 wt.-%, yet even more preferably in the range of 27.5 to 40.0 wt.-%, like in the range of 30.0 to 35.0 wt.-%.

The heterophasic polypropylene copolymer (HECO) preferably has an intrinsic viscosity (IV) determined according to DIN ISO 1628/1 in decalin at 135° C. of the XCS fraction of from 1.5 to 6.0 dl/g, more preferably from 1.5 to 5.0 dl/g, even more preferably from 1.5 to 3.0 dl/g, yet even more preferably from 2.0 to 2.5 dl/g.

According to one preferred embodiment of the invention, the heterophasic polypropylene copolymer (HECO) has
i) an ethylene content of the xylene cold soluble (XCS) fraction in the range of 20.0 to 55.0 wt. %, more preferably in the range of 22.5 to 50.0 wt.-%, even more preferably in the range of 25.0 to 45.0 wt.-%, yet even more preferably in the range of 27.5 to 40.0 wt.-%, like in the range of 30.0 to 35.0 wt.-%,
ii) a xylene cold soluble (XCS) content determined at 25° C. according ISO 16152 in the range of 5.0 to 45.0 wt. %, more preferably 10.0 to 42.5 wt.-%, even more preferably 15.0 to 40.0 wt.-%, yet even more preferably 20.0 to 40.0 wt.-%, like in the range of 25.0 to 35.0 wt.-%, based on the overall weight of the heterophasic polypropylene copolymer (HECO),
iii) an intrinsic viscosity (IV) determined according to DIN ISO 1628/1 in decalin at 135° C. of the XCS fraction of from 1.5 to 6.0 dl/g, more preferably from 1.5 to 5.0 dl/g, even more preferably from 1.5 to 3.0 dl/g, yet even more preferably from 2.0 to 2.5 dl/g.

The heterophasic polypropylene copolymer (HECO) preferably has a melt flow rate MFR₂ (230° C., 2.16 kg) determined according to ISO 1133 in the range of 4.0 to 50.0 g/10 min, more preferably in the range of 8.0 to 40.0 g/10 min, even more preferably 12.0 to 30 g/10 min, yet even more preferably 15.0 to 25.0 g/10 min, like in the range of 15.0 to 20.0 g/10 min.

It is further preferred that the heterophasic polypropylene copolymer (HECO) has a melting temperature Tm determined according to differential scanning calorimetry (DSC) in the range of 150 to 170° C.

The heterophasic polypropylene copolymer (HECO) is preferably produced in a multistage process known in the art, wherein the matrix being a propylene homopolymer (hPP) is produced at least in one slurry reactor and subsequently the elastomeric ethylene copolymer (E) is produced at least in one gas phase reactor. For example, reference is made to the process for preparing a heterophasic polypropylene copolymer (HECO) as described in WO 2013/149915 A1.

The heterophasic polypropylene copolymer (HECO) is preferably obtained using a heterogeneous catalyst system comprising (i) a magnesium-containing support (e.g. MgCl₂), and (ii) a titanium compound (e.g, TiCl₄). Preferably, the heterophasic polypropylene copolymer (HECO) is obtained using a heterogeneous Ziegler-Natta catalyst. Such catalysts are well-known in the art.

### The Additives (AD)

The fiber reinforced composition (C) may include additives (AD). The additives (AD) may be present in the fiber reinforced composition (C) in an amount of in the range of 0.01 to 5.0 wt.-%, preferably in the range of 0.1 to 4.0 wt.-%, more preferably in the range of 0.1 to 3.0 wt.-%, even more preferably in the range of 0.5 to 2.5 wt. %, like in the range of 1.0 to 2.0 wt.-%, based on the overall weight of the composition (C).

Typical additives are acid scavengers, antioxidants, colorants, light stabilisers, plasticizers, slip agents, anti-scratch agents, dispersing agents, processing aids, lubricants, pigments, and the like. Such additives are commercially available and for example described in “Plastic Additives Handbook”, 6th edition 2009 of Hans Zweifel (pages 1141 to 1190).

Furthermore, the term “additives (AD)” according to the present invention also includes carrier materials, in particular polymeric carrier materials. Said polymeric carrier material may be part of an additives masterbatch.

Preferably the fiber reinforced polypropylene composition (C) of the invention does not comprise further polymer(s) different to the propylene random copolymer (P), the heterophasic polypropylene copolymer (HECO), and the adhesion promoter (AP), in an amount exceeding 5.0 wt.-%, preferably in an amount exceeding 3.0 wt.-%, more preferably in an amount exceeding 2.0 wt.-%, based on the weight of the fiber reinforced polypropylene composition (C). Any polymer being a carrier material for additives (AD) is not calculated to the amount of polymeric compounds as indicated in the present invention, but to the amount of the respective additive.

The polymeric carrier material of the additives (AD) is a carrier polymer to ensure a uniform distribution in the fiber reinforced polypropylene composition (C) of the invention. The polymeric carrier material is not limited to a particular polymer. The polymeric carrier material may be ethylene homopolymer, ethylene copolymer obtained from ethylene and α-olefin comonomer such as C3 to C8 α-olefin comonomer, propylene homopolymer and/or propylene copolymer obtained from propylene and α-olefin comonomer such as ethylene and/or C4 to C8 α-olefin comonomer. It is preferred that the polymeric carrier material does not contain monomeric units derivable from styrene or derivatives thereof.

### The Article

The present invention also relates to an article, like an injection moulded article, comprising the fiber reinforced composition (C) as defined above.

The present invention in particular relates to an article, like an injection moulded article, comprising at least 60 wt.-%, more preferably at least 80 wt.-%, still more preferably at least 90 wt.-%, like at least 95 wt.-% or at least 99 wt.-%, of the fiber reinforced polypropylene composition (C) as defined above. In an especially preferred embodiment the present invention relates to an article, like an injection moulded article, consisting of the fiber reinforced composition (C) as defined above.

Preferably, the article is an automotive article, like an injection moulded automotive article.

In the following, the present invention is described by specific examples, which are however not to be understood as limiting the invention in any way.

### EXAMPLES

### 1. Measuring Methods

The following definitions of terms and determination methods apply for the above general description of the invention as well as to the below examples unless otherwise defined.

### Comonomer Content of 1-Butene for a Propylene 1-Butene Copolymer (P)

Quantitative ¹³C {¹H} NMR spectra recorded in the molten-state using a Bruker Avance III 500 NMR spectrometer operating at 500.13 and 125.76 MHz for ¹H and ¹³C respectively. All spectra were recorded using a ¹³C optimised 7 mm magic-angle spinning (MAS) probehead at 180° C. using nitrogen gas for all pneumatics. Approximately 200 mg of material was packed into a 7 mm outer diameter zirconia MAS rotor and spun at 4 kHz. This setup was chosen primarily for the high sensitivity needed for rapid identification and accurate quantification. (Klimke, K., Parkinson, M., Piel, C., Kaminsky, W., Spiess, H. W., Wilhelm, M., Macromol. Chem. Phys. 2006; 207:382, Parkinson, M., Klimke, K., Spiess, H. W., Wilhelm, M., Macromol. Chem. Phys. 2007; 208:2128, Castignolles, P., Graf, R., Parkinson, M., Wilhelm, M., Gaborieau, M., Polymer 50 (2009) 2373). Standard single-pulse excitation was employed utilising the NOE at short recycle delays of 3 s (Klimke, K., Parkinson, M., Piel, C., Kaminsky, W., Spiess, H. W., Wilhelm, M., Macromol. Chem. Phys. 2006; 207:382, Pollard, M., Klimke, K., Graf, R., Spiess, H. W., Wilhelm, M., Sperber, O., Piel, C., Kaminsky, W., Macromolecules 2004; 37:813). and the RS-HEPT decoupling scheme (Filip, X., Tripon, C., Filip, C., J. Mag. Resn. 2005, 176, 239, Griffin, J. M., Tripon, C., Samoson, A., Filip, C., and Brown, S. P., Mag. Res. in Chem. 2007 45, S1, S198). A total of 16384 (16 k) transients were acquired per spectra.

Quantitative ¹³C {¹H} NMR spectra were processed, integrated and relevant quantitative properties determined from the integrals. All chemical shifts are internally referenced to the methyl isotactic pentad (mmmm) at 21.85 ppm.

Characteristic signals corresponding to the incorporation of 1-butene were observed and the comonomer content quantified in the following way.

The amount 1-butene incorporated in PPBPP isolated sequences was quantified using the integral of the αB2 sites at 43.6 ppm accounting for the number of reporting sites per comonomer:

$$B = I α / 2$$

The amount of 1-butene incorporated in PPBBPP double consecutively sequences was quantified using the integral of the ααB2B2 site at 40.5 ppm accounting for the number of reporting sites per comonomer:

$$BB = 2 * I α α$$

When double consecutive incorporation was observed the amount of 1-butene incorporated in PPBPP isolated sequences needed to be compensated due to the overlap of αB2 and αB2B2 signals at 43.9 ppm:

$$B = ( I α - 2 * I α α ) / 2$$

The total 1-butene content was calculated based on the sum of isolated and consecutively incorporated 1-butene:

$${B}_{total} = B + BB$$

The amount of propene was quantified based on the main Sαα methylene sites at 46.7 ppm and compensating for the relative amount of αB2 and ααB2B2 methylene unit of propene not accounted for (note B and BB count number of butane monomers per sequence not the number of sequences):

$${P}_{total} = {I}_{S} α α + B + BB / 2$$

With characteristic signals corresponding to regio defects observed (Resconi, L., Cavallo, L., Fait, A., Piemontesi, F., Chem. Rev. 2000, 100, 1253), the compensation for misinserted propylene units was used for Ptotal.

In case of 2,1-erythro mis-insertions presence the signal from ninth carbon (S₂₁ₑ₉) of this microstructure element (Resconi, L., Cavallo, L., Fait, A., Piemontesi, F., Chem. Rev. 2000, 100, 1253) with chemical shift at 42.5 ppm was chosen for compensation. In this case:

$${P}_{total} = {I}_{S} α α + B + BB / 2 + 3 * I ( {S}_{21 e 9} )$$

The total mole fraction of 1-butene in the polymer was then calculated as:

$$fB = ( {B}_{total} / ( {B}_{total} + {P}_{total} )$$

The total comonomer incorporation of 1-butene in mole percent was calculated from the mole fraction in the usual manner:

$$B [ mol - \% ] = 100 * fB$$

The total comonomer incorporation of 1-butene in weight percent was calculated from the mole fraction in the standard manner:

$$B [ wt \% ] = 100 * ( fB * 56.11 ) / ( ( fB * 56.11 ) + ( ( 1 - fB ) * 42.08 ) )$$

Calculation of comonomer content of the second propylene random copolymer (P2):

$$\frac{C ( P ) - w ( P 1 ) \times C ( P 1 )}{w ( P 2 )} = C ( P 2 )$$

wherein
w(P1) is the weight fraction of the first propylene random copolymer (P1),
w(P2) is the weight fraction of the second propylene random copolymer (P2),
C(P1) is the comonomer content [in mol-%] measured by ¹³C NMR spectroscopy of the first propylene random copolymer (P1), i.e. of the product of the first reactor (R1),
C(P) is the comonomer content [in mol-%] measured by ¹³C NMR spectroscopy of the product obtained in the second reactor (R2), i.e. the mixture of first propylene random copolymer (P1), and the second propylene random copolymer (P2) [of the propylene random copolymer (P)],
C(P2) is the calculated comonomer content [in mol-%] of the second propylene random copolymer (P2)

### Ethylene Content in C2C3 RACO and C2C3 HECO

Quantitative nuclear-magnetic resonance (NMR) spectroscopy was used to quantify the comonomer content of the polymers. Quantitative ¹³C {¹H} NMR spectra were recorded in the solution-state using a Bruker Advance III 400 NMR spectrometer operating at 400.15 and 100.62 MHz for ¹H and ¹³C respectively. All spectra were recorded using a ¹³C optimised 10 mm extended temperature probehead at 125° C. using nitrogen gas for all pneumatics. Approximately 200 mg of material was dissolved in 3 ml of 1,2-tetrachloroethane-d₂ (TCE-d₂) along with chromium-(III)-acetylacetonate (Cr(acac)₃) resulting in a 65 mM solution of relaxation agent in solvent (Singh, G., Kothari, A., Gupta, V., Polymer Testing 28 5 (2009), 475). To ensure a homogenous solution, after initial sample preparation in a heat block, the NMR tube was further heated in a rotatory oven for at least 1 hour. Upon insertion into the magnet the tube was spun at 10 Hz. This setup was chosen primarily for the high resolution and quantitatively needed for accurate ethylene content quantification. Standard single-pulse excitation was employed without NOE, using an optimised tip angle, 1 s recycle delay and a bi-level WALTZ16 decoupling scheme (Zhou, Z., Kuemmerle, R., Qiu, X., Redwine, D., Cong, R., Taha, A., Baugh, D. Winniford, B., J. Mag. Reson. 187 (2007) 225; Busico, V., Carbonniere, P., Cipullo, R., Pellecchia, R., Severn, J., Talarico, G., Macromol. Rapid Commun. 2007, 28, 1128). A total of 6144 (6 k) transients were acquired per spectra.

Quantitative ¹³C {¹H} NMR spectra were processed, integrated and relevant quantitative properties determined from the integrals using proprietary computer programs. All chemical shifts were indirectly referenced to the central methylene group of the ethylene block (EEE) at 30.00 ppm using the chemical shift of the solvent. This approach allowed comparable referencing even when this structural unit was not present. Characteristic signals corresponding to the incorporation of ethylene were observed Cheng, H. N., Macromolecules 17 (1984), 1950).

With characteristic signals corresponding to 2,1 erythro regio defects observed (as described in L. Resconi, L. Cavallo, A. Fait, F. Piemontesi, Chem. Rev. 2000, 100 (4), 1253, in Cheng, H. N., Macromolecules 1984, 17, 1950, and in W-J. Wang and S. Zhu, Macromolecules 2000, 33 1157) the correction for the influence of the regio defects on determined properties was required. Characteristic signals corresponding to other types of regio defects were not observed.

The comonomer fraction was quantified using the method of Wang et. al. (Wang, W-J., Zhu, S., Macromolecules 33 (2000), 1157) through integration of multiple signals across the whole spectral region in the ¹³C {¹H} spectra. This method was chosen for its robust nature and ability to account for the presence of regio-defects when needed. Integral regions were slightly adjusted to increase applicability across the whole range of encountered comonomer contents. For systems where only isolated ethylene in PPEPP sequences was observed the method of Wang et. al. was modified to reduce the influence of non-zero integrals of sites that are known to not be present. This approach reduced the overestimation of ethylene content for such systems and was achieved by reduction of the number of sites used to determine the absolute ethylene content to:

$$E = 0.5 ( S β β + S β γ + S β δ + 0.5 ( S αβ + S α γ ) )$$

Through the use of this set of sites the corresponding integral equation becomes:

$$E = 0.5 ( {I}_{H} + {I}_{G} + 0.5 ( {I}_{C} + {I}_{D} ) )$$

using the same notation used in the article of Wang et. al. (Wang, W-J., Zhu, S., Macromolecules 33 (2000), 1157). Equations used for absolute propylene content were not modified.

The mole percent comonomer incorporation was calculated from the mole fraction:

$$E [ mol \% ] = 100 * {f}_{E}$$

The weight percent comonomer incorporation was calculated from the mole fraction:

$$E [ wt \% ] = 100 * ( {f}_{E} * 28. 06 ) / ( ( {f}_{E} * 28. 06 ) + ( ( 1 - {f}_{E} ) * 42. 08 ) )$$

The comonomer sequence distribution at the triad level was determined using the analysis method of Kakugo et al. (Kakugo, M., Naito, Y., Mizunuma, K., Miyatake, T. Macromolecules 15 (1982) 1150). This method was chosen for its robust nature and integration regions slightly adjusted to increase applicability to a wider range of comonomer contents.

### Melt Flow Rate (MFR)

The melt flow rates MFR₂ were measured according to ISO 1133 with a load of 2.16 kg at 230° C. for propylene copolymers and with a load of 2.16 kg at 190° C. for ethylene copolymers. The melt flow rate is that quantity of polymer in grams which the test apparatus standardised to ISO 1133 extrudes within 10 minutes at a temperature of 230° C., respectively 190° C., under a load of 2.16 kg.

The xylene cold solubles (XCS, wt.-%): Content of xylene cold solubles (XCS) was determined at 25° C. according ISO 16152; first edition; 2005 Jul. 1.

Melting temperature Tₘ, crystallization temperature T_{c}, was measured with Mettler TA820 differential scanning calorimetry (DSC) on 5-7 mg samples. DSC was run according to ISO 11357/part 3/method C₂ in a heat/cool/heat cycle with a scan rate of 10° C./min in the temperature range of −30 to +225° C. Crystallization temperature was determined from the cooling step, while melting temperature was determined from the second heating step. All mechanical measurements were conducted after 96 h conditioning time (at 23° C. at 50% relative humidity) of the test specimen.

The glass transition temperature Tg was determined by dynamic mechanical analysis according to ISO 6721-7. The measurements were done in torsion mode on compression moulded samples (40×10×1 mm³) between −100° C. and +150° C. with a heating rate of 2° C./min and a frequency of 1 Hz.

Charpy unnotched impact strength was determined according to ISO 179-1/1 eU at 23° C. by using injection moulded test specimens (80×10×4 mm) prepared according to EN ISO 1873-2.

Tensile properties were determined on injection moulded dogbone specimens of 4 mm thickness prepared in accordance with EN ISO 1873-2. Tensile modulus was determined according to ISO 527-1A at a strain rate of 1 mm/min and 23° C., tensile strength and elongation (strain) at break were determined according to ISO 527-2 at a strain rate of 50 mm/min and 23° C.

### Heat Deflection Temperature (HDT):

The HDT was determined on injection moulded test specimens of 80×10×4 mm³ prepared according to ISO 1873-2. The test was performed on flatwise supported specimens according to ISO 75, condition A, with a nominal surface stress of 1.80 MPa.

VOC/Fog emission was measured according to VDA 278:2002 on injection moulded test specimen and on the granulated compounds. The volatile organic compounds were measured in toluene equivalents per gram. The fogging was measured in hexadecane equivalents per gram.

The measurements were carried out with a TDSA supplied by Gerstel using helium 5.0 as carrier gas and a column HP Ultra 2 of 50 m length and 0.32 mm diameter and 0.52 μm coating of 5% Phenyl-Methyl-Siloxane.

The VOC-Analysis was done according to device setting 1 listed in the standard using following main parameters: flow mode splitless, final temperature 90° C.; final time 30 min, rate 60K/min. The cooling trap was purged with a flow-mode split 1:30 in a temperature range from −150° C. to +280° C. with a heating rate of 12 K/see and a final time of 5 min. The following GC settings were used for analysis: 2 min isothermal at 40° C. heating at 3 K/min up to 92° C., then at 5 K/min up to 160° C., and then at 10 K/min up to 280° C., 10 minutes isothermal; flow 1.3 ml/min.

The fog analysis was done according to device setting 1 listed in the standard using following main parameters: flow-mode splitless, rate 60 K/min; final temperature 120° C.; final time 60 min. The cooling trap was purged with a flow-mode split 1:30 in a temperature range from −150° C. to +280° C. with a heating rate of 12 K/sec. The following GC-settings were used for analysis: isothermal at 50° C. for 2 min, heating at 25 K/min up to 160° C., then at 10 K/min up to 280° C., 30 minutes isothermal; flow 1.3 ml/min.

### 2. Examples

### Preparation of the Catalyst

The metallocene compound (MC-2) (rac-anti-dimethylsilanediyl [2-methyl-4,8-bis(3′,5′-dimethyl phenyl)-1,5,6,7-tetrahydro-s-indacen-1-yl] [2-methyl-4-(3′,5′-dimethylphenyl)-5-methoxy-6-tert-butylinden-1-yl]zirconium dichloride) has been synthesized as described in WO2019/179959 for MC-2.

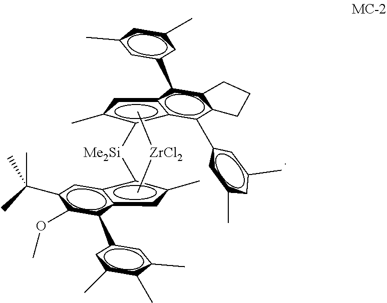

The catalyst was prepared using metallocene MC-2 and a catalyst system of MAO and trityl tetrakis(pentafluorophenyl) borate according to the process for preparing the metallocene catalyst described in the example of WO 2021/233771. This catalyst was used for preparing the random propylene copolymers P.

### Preparation of the Random Propylene Copolymer (P)

The random propylene copolymer (P) was prepared in a sequential process comprising a loop reactor and a gas phase reactor. The reaction conditions are summarized in Table 1.

TABLE 1
Preparation of the random propylene copolymer (P)

| | | P |
|---|---|---|
| Prepolymerization | | |
| Temperature | [° C.] | 20 |
| Pressure | [kPa] | 4135 |
| Catalyst feed | [g/h] | 2.6 |
| TEAL/C3 | [g/t] | 0 |
| C3 feed | [kg/h] | 70.0 |
| H2 feed | [g/h] | 0.1 |
| Residence time | [h] | 0.4 |
| Loop (R1) | | |
| Temperature | [° C.] | 68 |
| Pressure | [kPa] | 4897 |
| H2/C3 ratio | [mol/kmol] | 0.23 |
| C4/C3 ratio | [mol/kmol] | 48.0 |
| MFR₂ (loop) | [g/10 min] | 70.6 |
| C4 (loop) | [mol-%] | 4.4 |
| Residence time | [h] | 0.5 |
| Split (loop) | [wt.-%] | 49 |
| GPR (R2) | | |
| Temperature | [° C.] | 80 |
| Pressure | [kPa] | 2498 |
| H2/C3 ratio | [mol/kmol] | 2.3 |
| C4/C3 ratio | [mol/kmol] | 40.2 |
| C4 (GPR) calc. | [mol-%] | 6.6 |
| Residence time | [h] | 2.3 |
| Split (GPR) | [wt.-%] | 51 |
| C4 (total) | [mol-%] | 5.5 |
| XCS (total) | [wt.-%] | 0.4 |
| 1,2e regiodefects | [mol-%] | 0.9 |
| MFR₂ (copolymer) | [g/10 min] | 94 |
| Tm | [° C.] | 140 |
| Tg | [° C.] | −2.0 |

The obtained copolymer was compounded without visbreaking, using a basic antioxidant combination for stabilization. Copolymer P is a C3C4 random copolymer having a melt flow rate MFR₂ (230° C., 2.16 kg) of 94 g/10 min, a C4 comonomer content of 5.5 mol-%, which does not contain nucleating agent. P has a melting temperature Tm determined according to differential scanning calorimetry (DSC) of 140° C. and a crystallization temperature Tc according to differential scanning calorimetry (DSC) of 105° C.

### Preparation of the Fiber Reinforced Composition (C)

The fiber reinforced composition (C) was obtained by melt blending the propylene random copolymer (P) with the glass fibers (GF), the heterophasic propylene copolymer (HECO), the adhesion promoter (AP) and the additives (AD) in a co-rotating twin screw extruder. The composition and properties of the inventive and comparative examples are summarized in Table 2.

TABLE 2
Composition of inventive and comparative examples

| | | IE1 | IE2 | CE1 | CE2 | CE3 | CE4 |
|---|---|---|---|---|---|---|---|
| P | wt % | 42.1 | 47.1 | — | — | — | — |
| P-a | wt % | — | — | — | 76.5 | 42.1 | 52.1 |
| P-b | wt % | — | — | 77.1 | — | — | — |
| HECO | wt % | 35 | 30 | — | — | 35 | 25 |
| GF | wt % | 20 | 20 | 20 | 20 | 20 | 20 |
| AP | wt % | 1.5 | 1.5 | 1.5 | 1.5 | 1.5 | 1.5 |
| AD1 | wt % | 1.4 | 1.4 | 1.4 | — | 1.4 | 1.4 |
| AD2 | | — | — | — | 2.0 | — | — |
| Melt flow rate | g/10 min | 18 | 18 | 8 | 16 | 12 | 11.5 |
| Tensile | MPa | 4278 | 4529 | 4688 | 4294 | 4242 | 4280 |
| modulus | | | | | | | |
| Tensile | MPa | 75.1 | 78.6 | 82.7 | 77.2 | 72.1 | 75.6 |
| strength | | | | | | | |
| Elongation at | % | 3.4 | 3.3 | 3.8 | 3.6 | 3.8 | 3.2 |
| break | | | | | | | |
| Charpy | kJ/m² | 53.2 | 51.5 | 52.4 | 45.9 | 52.0 | 50.7 |
| unnotched | | | | | | | |
| (ISO 179 1eU | | | | | | | |
| 23° C.) | | | | | | | |
| HDT | ° C. | 148 | 149 | 138 | 138 | 150 | 149 |
| VOC | μg/g | 12 | 11 | 3 | 32 | 85 | 89 |
| Fog | μg/g | 76 | 72 | 77 | 86 | 177 | 192 |

P is the C3C4 random copolymer as described above in Table 1.
P-a is a Ziegler-Natta catalyst-based high flow C2C3 random copolymer, which is produced by visbreaking a reactor grade C2C3 copolymer to MFR (230° C.; 2.16 kg) 75 g/10 min; it has a melting temperature Tm of 145° C. It has no detectable 1,2 erythro regio-defects, i.e., 1,2 erythro regio-defects are 0 mol-%.
P-b is a metallocene catalyst-based C3C4 random copolymer, which has a MFR (230° C.; 2.16 kg) of 21 g/10 min, C4 comonomer content of 4.3 mol-%, with 2000 ppm of a nucleating agent and 2 wt % of a propylene homopolymer (HF955MO commercially available from Borealis). It has a melting temperature Tm of 146° C. and a crystallization temperature Tc of 118° C.; the amount of 1,2 erythro regio-defects is about 0.9 mol-%.
HECO is the commercial product EF015AE by Borealis, which is a Ziegler-Natta-based in-reactor heterophasic propylene copolymer (rTPO) with a MFR 18 g/10 min (230° C.; 2.16 kg), an XCS content of 31.5 wt.-% with C2(XCS) of 44.8 wt.-% and iV(XCS) of 2.3 dl/g; it has a melting temperature Tm of 165° C.
GF is the commercial product ECS 03 T-480H of Nippon Electric Glass Co., Ltd. having a filament diameter of 10.5 μm and a strand length of 3 mm.
AP is the adhesion promoter SCONA TPPP 8112 GA by Scona being a polypropylene functionalized with maleic anhydride having a maleic anhydride content of 1.4 wt.-% and an MFR (190° C., 2.16 kg) above 80 g/10 min, corresponding to an MFR₂ (230° C., 2.16 kg) of about 50 g/10 min.
AD1 is a masterbatch consisting of 14.3 wt.-% tris(2,4-di-t-butylphenyl)phosphite (Kinox-68-G by HPL Additives), 14.3 wt.-% of pentaerythrityl-tetrakis(3-(3′,5′-di-tert. butyl-4-hydroxyphenyl)-propionate (Irganox 1010FF by BASF), 35.7 wt.-% of carbon black (39.5 wt.-% masterbatch) by Borealis, and 35.7 wt.-% of the propylene homopolymer HC001A by Borealis having a density determined according to ISO 1183-187 of 905 kg/m³ and a MFR (230° C., 2.16 kg) of 3.2 g/10 min.
AD2 is a masterbatch consisting of 10.0 wt.-% Tris(2,4-di-t-butylphenyl)phosphite (Kinox-68-G by HPL Additives), 10.0 wt.-% of pentaerythrityl-tetrakis(3-(3′,5′-di-tert. butyl-4-hydroxyphenyl)-propionate (Irganox 1010FF by BASF), 25.0 wt.-% of carbon black (39.5 wt.-% masterbatch) by Borealis, and 55.0 wt.-% of the propylene homopolymer HC001A by Borealis having a density determined according to ISO 1183-187 of 905 kg/m³ and a MFR (230° C., 2.16 kg) of 3.2 g/10 min.

1. A fiber reinforced composition (C),
wherein the fiber reinforced composition (C) has a melt flow rate MFR₂ (230° C., 2.16 kg) determined according to ISO 1133 in a range of 10.0 to 100.0 g/10 min,
wherein the fiber reinforced composition (C) comprises:
a) 20.0 to 89.9 wt.-% of a propylene random copolymer (P),
wherein the propylene random copolymer (P) is a copolymer of propylene and at least one comonomer selected from C4 to C12 α-olefins,
wherein the propylene random copolymer (P) has an amount of 1,2 erythro regio-defects in a range of 0.4 to 1.2 mol-%,
b) 5.0 to 45.0 wt.-% of glass fibers (GF),
c) 0.1 to 5.0 wt.-% of an adhesion promoter (AP), and
d) 5.0 to 50.0 wt.-% of a heterophasic polypropylene copolymer (HECO),
based on the overall weight of the fiber reinforced composition (C).

2. The fiber reinforced composition according to claim 1, wherein the propylene random copolymer (P) has a melt flow rate MFR₂ (230° C., 2.16 kg) determined according to ISO 1133 in a range of 45 to 150 g/10 min.

3. The fiber reinforced composition (C) according to claim 1, wherein the propylene random copolymer (P) has a melting temperature Tm determined according to differential scanning calorimetry (DSC) in a range of 125 to 150° C.

4. The fiber reinforced composition (C) according to claim 1, wherein the propylene random copolymer (P) has a comonomer content in a range of 2.5 to 10.0 mol-%.

5. The fiber reinforced composition (C) according to claim 1, wherein the propylene random copolymer (P) is a copolymer of propylene and 1-butene.

6. The fiber reinforced composition (C) according to claim 1, wherein the propylene random copolymer (P) comprises:
i) a first propylene random copolymer (P1), and
ii) a second propylene random copolymer (P2) having a higher comonomer content than the first propylene random copolymer (P1),
wherein a weight ratio between the first propylene random copolymer (P1) and the second propylene random copolymer (P2) is in a range of 20/80 to 60/40 and a combined amount of the first propylene random copolymer (P1) and the second propylene random copolymer (P2) is at least 95.0 wt.-%, based on the propylene random copolymer (P).

7. The fiber reinforced composition (C) according to claim 1, wherein the propylene random copolymer (P) comprises:
i) a first propylene random copolymer (P1) having a comonomer content in a range of 2.0 to 6.0 mol-%, and
ii) a second propylene random copolymer (P2) having a comonomer content in a range of 4.0 to 14.0 mol-%, wherein the comonomer content of the second propylene random copolymer (P2) is different than the comonomer content of the first propylene random copolymer (P1).

8. The fiber reinforced composition (C) according to claim 1, wherein the glass fibers (GF) have:
i) an average length of 1.0 to 10.0 mm, and/or
ii) an average diameter of 5 to 20 μm.

9. The fiber reinforced composition (C) according to claim 1, wherein the adhesion promoter (AP) is a polar modified propylene homo- or copolymer (PM-PP).

10. The fiber reinforced composition (C) according to claim 1, wherein the heterophasic polypropylene copolymer (HECO) comprises:
i) a matrix being a propylene homopolymer (hPP), and
ii) an elastomeric ethylene copolymer (E) being dispersed in the matrix, wherein the elastomeric ethylene polymer (E) is a copolymer of ethylene and propylene, and optionally at least one comonomer selected from C4 to C12 α-olefins.

11. The fiber reinforced composition (C) according to claim 1, wherein the heterophasic polypropylene copolymer (HECO) has one or more of:
i) an ethylene content of a xylene cold soluble (XCS) fraction in a range of 20.0 to 55.0 wt. %,
ii) a xylene cold soluble (XCS) content determined at 25° C. according ISO 16152 in a range of 5.0 to 45.0 wt. %, based on the overall weight of the heterophasic polypropylene copolymer (HECO),
iii) an intrinsic viscosity (IV) determined according to DIN ISO 1628/1 in decalin at 135° C. of a XCS fraction of from 1.5 to 6.0 dl/g.

12. The fiber reinforced composition (C) according to claim 1, wherein the heterophasic polypropylene copolymer (HECO) has a melt flow rate MFR₂ (230° C., 2.16 kg) determined according to ISO 1133 in a range of 4.0 to 50.0 g/10 min.

13. The fiber reinforced composition (C) claim 1, wherein the propylene random copolymer (P) is obtained in the presence of a solid catalyst system (SCS) comprising a metallocene compound.

14. The fiber reinforced composition (C) according to claim 13, wherein the solid catalyst system (SCS) comprises (i) the metallocene compound of formula (I): 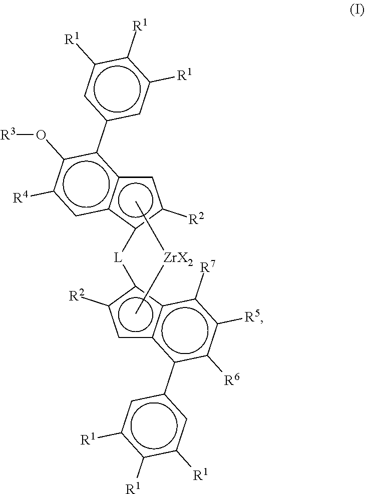
each X independently is a sigma-donor ligand,
L is a divalent bridge selected from —R′₂C—, —R′₂C—CR′₂—, —R′₂Si—, —R′₂Si—SiR′₂—, —R′₂Ge—, wherein each R′ is independently a hydrogen atom or a C₁-C₂₀-hydrocarbyl group optionally containing one or more heteroatoms of Group 14-16 of the periodic table or fluorine atoms, or optionally two R′ groups taken together form a ring,
each R¹ are independently the same or different, and are hydrogen, a linear or branched C₁-C₆-alkyl group, a C₇₋₂₀ arylalkyl, C₇₋₂₀ alkylaryl group or C₆₋₂₀ aryl group or an OY group, wherein Y is a C₁₋₁₀ hydrocarbyl group, and optionally two adjacent R¹ groups are part of a ring including the phenyl carbons to which they are bonded,
each R² independently are the same or different, and are a CH₂—R⁸ group, with R⁸ being H or linear or branched C₁₋₆-alkyl group, C₃₋₈ cycloalkyl group, C₆₋₁₀ aryl group,
R³ is a linear or branched C₁-C₆-alkyl group, C₇₋₂₀ arylalkyl, C₇₋₂₀ alkylaryl group or C₆-C₂₀-aryl group,
R⁴ is a C(R⁹)₃ group, with R⁹ being a linear or branched C₁-C₆ alkyl group,
R⁵ is hydrogen or an aliphatic C₁-C₂₀ hydrocarbyl group optionally containing one or more heteroatoms from groups 14-16 of the periodic table of elements;
R⁶ is hydrogen or an aliphatic C₁-C₂₀ hydrocarbyl group optionally containing one or more heteroatoms from groups 14-16 of the periodic table of elements; or
R⁵ and R⁶ are optionally taken together to form a 5 membered saturated carbon ring which is optionally substituted by n groups R¹⁰, n being from 0 to 4;
each R¹⁰ is same or different, and may be a C₁-C₂₀ hydrocarbyl group, or a C₁-C₂₀ hydrocarbyl radical optionally containing one or more heteroatoms belonging to groups 14-16 of the periodic table of elements;
R⁷ is H or a linear or branched C₁-C₆-alkyl group or an aryl or heteroaryl group having 6 to 20 carbon atoms optionally substituted by one to 3 groups R¹,
(ii) a cocatalyst system comprising a boron containing cocatalyst and/or an aluminoxane cocatalyst and
(iii) optionally a silica support.

15. An article comprising the fiber reinforced composition (C) according to claim 1.

16. The fiber reinforced composition (C) according to claim 7, wherein the comonomer content of the second propylene random copolymer (P2) is higher than the comonomer content of the first propylene random copolymer (P1).

17. The fiber reinforced composition (C) according to claim 9, wherein the polar modified propylene homo- or copolymer (PM-PP) comprises polar groups selected from the group consisting of acid anhydrides, carboxylic acids, carboxylic acid derivatives, primary and secondary amines, hydroxyl compounds, oxazoline and epoxides, ionic compounds, and combinations thereof.

18. The fiber reinforced composition (C) according to claim 1, wherein the heterophasic polypropylene copolymer (HECO) has:
i) an ethylene content of a xylene cold soluble (XCS) fraction in a range of 20.0 to 55.0 wt. %,
ii) a xylene cold soluble (XCS) content determined at 25° C. according ISO 16152 in a range of 5.0 to 45.0 wt. %, based on the overall weight of the heterophasic polypropylene copolymer (HECO),
iii) an intrinsic viscosity (IV) determined according to DIN ISO 1628/1 in decalin at 135° C. of a XCS fraction of from 1.5 to 6.0 dl/g.

19. The fiber reinforced composition (C) according to claim 1, wherein the heterophasic polypropylene copolymer (HECO) has a melting temperature Tm determined according to differential scanning calorimetry (DSC) in a range of 150 to 170° C.

20. The fiber reinforced composition (C) according to claim 1, wherein the heterophasic polypropylene copolymer (HECO) has:
(i) a melt flow rate MFR₂ (230° C., 2.16 kg) determined according to ISO 1133 in a range of 4.0 to 50.0 g/10 min, and
(ii) a melting temperature Tm determined according to differential scanning calorimetry (DSC) in a range of 150 to 170° C.
